(19) United States
(12) Patent Application Publication
(10) Pub. No.: US 2009/0220770 A1
(43) Pub. Date: Sep. 3, 2009

(54) POLYMERIZABLE COMPOSITION, HIGH-REFRACTIVE-INDEX RESIN COMPOSITION, AND OPTICAL MEMBER MADE OF THE SAME

(75) Inventors: Nobuhiko Ueno, Kanagawa (JP); Takeshi Otsu, Kanagawa (JP); Katsuya Amako, Kanagawa (JP)

Correspondence Address: OBLON, SPIVAK, MCCLELLAND MAIER & NEUSTADT, P.C., 1940 DUKE STREET, ALEXANDRIA, VA, 22314, US

(73) Assignees: MITSUBISHI CHEMICAL CORPORATION, Minato-ku (JP); Sony Corporation, Minato-ku (JP)

(21) Appl. No.: 12/298,801

(22) PCT Filed: Apr. 25, 2007
(86) PCT No.: PCT/JP2007/058969

§ 371 Date: Apr. 27, 2009

(30) Foreign Application Priority Data
Apr. 28, 2006 (JP) 2006-126430
Apr. 19, 2007 (JP) 2007-110687

(51) Int. Cl. B32B 5/16; C08F 28/02

(52) U.S. Cl. 428/328; 525/328.5

(57) ABSTRACT

The invention can provide a high-refractive-index resin composition containing particles, more particularly, a resin composition having a high refractive index and usable in optical applications including coatings and lenses. The high-refractive-index resin composition of the invention is a high-refractive-index resin composition obtained by polymerizing a polymerizable composition containing particles coated with a surface-treating agent and having an average particle diameter of 10 nm or smaller and a polymerizable monomer, wherein the content of the particles excluding the surface-treating agent, X (% by mass), and the refractive index of the high-refractive-index resin composition, Y (n²³d), have a relationship between these which is represented by the general formula 1: Y≧0.0035X+1.52 (wherein 20≦X≦60 and Y≦2.0).

### TECHNICAL FIELD

The present invention relates to a resin composition containing high-refractive-index particles. More particularly, the invention relates to a resin composition having a high refractive index and usable in optical applications including coatings and lenses.

### BACKGROUND ART

Various lenses made of glass have conventionally been used. However, glass lenses have a high specific gravity and are unsuitable for sufficiently meeting the desire for weight and thickness reduction in various applications. Glass lenses further have problems concerning formability and processability. Because of this, resinous lenses are attracting attention which are lightweight, have high mechanical strength, and are easy to process/mold. However, resins have a low refractive index and, hence, it has been difficult to attain a lens thickness reduction. Although investigations have hitherto been made in order to heighten the refractive index of a resin itself, it has been difficult to obtain a resin having a refractive index (n_{D}) exceeding 1.6.

On the other hand, attention is recently directed to nanoparticles. The term nanoparticles generally means particles having a primary particle diameter of 100 nm or smaller. Particles each having a size of 100 nm or smaller are nanoparticles regardless of whether the particles have been aggregated or a represent independently. Nanoparticles include ones made of many kinds of oxides depending on the kinds of metal elements. Among these nanoparticles are ones having a refractive index as high as 2.4. There is a growing trend toward the development of a material having a higher refractive index by adding metallic nanoparticles having a high refractive index to a base resin.

For example, patent document 1 describes as an example a nanocomposite constituted of nanoparticles whose surface has been modified with both of an acidic group and a basic group and a polymer having electron-donating properties. However, these surface-modified particles have poor compatibility with (meth)acrylic monomers and poor dispersibility, and the nanocomposite obtained has low transparency.

Non-patent document 1 proposes titanium oxide nanoparticles coated with dodecylbenzenesulfonic acid. However, because of the use of dodecylbenzenesulfonic acid, which has a low refractive index, the coated nanoparticles as a whole have a low refractive index. Furthermore, the coated nanoparticles have poor compatibility with (meth)acrylic monomers. It is therefore expected that these nanoparticles give a nanocomposite having low transparency.

Examples of techniques for adding metallic nanoparticles to a base resin include methods such as a method in which nanoparticles are mixed with a resin or a monomer (e.g., by kneading) and a method in which nanoparticles are produced from a corresponding precursor in a resin or a monomer (sol-gel method). In general, however, a method is frequently employed in which a solvent containing nanoparticles dispersed therein is evenly mixed with a UV-curable liquid monomer and the resultant mixture is subjected to polymerization reaction to obtain a resin.

Patent document 2 describes as an example a mixture of a composite metal oxide and a UV-curable monomer. The composite metal oxide used here is nanoparticles whose surface has undergone no treatment.

In an Example given therein, the mixture was produced and formed into a thin film of 20 μm, and this film was examined for haze to show the high transparency thereof. However, no Example is given which relates to a thick film such as, e.g., a lens. In the case where the mixture is actually formed into a thick film, there is a problem that this film has turbidity. Furthermore, this mixture has a drawback that it has poor stability and becomes turbid with the lapse of time.

Patent document 3 describes examples of a metal oxide colloid from which a highly transparent nanocomposite material can be produced. However, those examples of the surface-treating agent (dispersing agent) used here which are given therein are limited to ones having a low refractive index. For attaining an increased refractive index, it is necessary to add the nanoparticles, which have a higher refractive index than resins and monomers, in a large amount. However, this gives a composite having an increased viscosity and poor moldability.

On the other hand, when the surface of nanoparticles is treated with a surface-treating agent such as, e.g., a commercial silane coupling agent, the coated nanoparticles have a drawback that they have a reduced refractive index. The coated nanoparticles described in non-patent document 1 have had a drawback that because of their low refractive index, it is necessary to add the coated nanoparticles in a large amount for improving the refractive index of a resin.

Patent document 4 describes as an example a resin molding obtained by curing a polymerizable composition constituted of a bifunctional (meth)acrylate compound and titanium oxide having an average particle diameter of 20 nm. This technique is intended to attain high transparency, a high refractive index, and reduced birefringence. However, there has been a problem that because of the large average particle diameter, the resin molding has a reduced transmittance (transparency) and an increased haze. Furthermore, the surface-treating agent used therein is a silane coupling agent having a low refractive index, and this may pose the following problem. In the case where nanoparticles having a small average particle diameter are used, it is especially necessary to use the surface-treating agent in a far larger amount and this results in a reduced refractive index.

### Patent Document 1: JP-A-2003-73558

### Patent Document 2: JP-A-2004-176006

Patent Document 3: JP-T-2002-521305 (The term “JP-T” as used herein means a published Japanese translation of a PCT patent application.)

### Patent Document 4: JP-A-2005-314661

### Non-Patent Document 1: Journal of Nanoparticle Research, 4: 319-323, 2002

### DISCLOSURE OF THE INVENTION

### Problems that the Invention is to Solve

An object of the invention is to provide a resin composition containing high-refractive-index particles.

### Means for Solving the Problems

The present inventors diligently made investigations in order to accomplish the object. As a result, they have found that when a surface-treating agent having a specific chemical structure is used for the treatment of the surface of particles, then particles having an intact high refractive index and excellent compatibility with (meth)acrylic monomers can be obtained, and that a high-refractive-index resin composition can be obtained by mixing these particles with a high-refractive-index monomer and polymerizing the mixture. The invention has been achieved based on these findings.

Namely, the invention includes the following constitutions.

(1) A high-refractive-index resin composition obtained by polymerizing a polymerizable composition comprising: particles at least coated with a surface-treating agent and having an average particle diameter of 10 nmo r smaller; and a polymerizable monomer, wherein the content of the particles excluding the surface-treating agent, X (% by mass), and the refractive index of the high-refractive-index resin composition, Y (n²³_{d}), have a relationship between these which is represented by the following general formula 1:

Y≧0.0035X+1.52

(wherein 20≦x≦60 and Y≦2.0) (first aspect).
(2) A high-refractive-index resin composition having a refractive index (n²³_{d}) of 1.66 or higher and obtained by polymerizing a polymerizable composition comprising: particles at least coated with a surface-treating agent; and a polymerizable monomer, wherein the content of the particles excluding the surface-treating agent is from 20% by mass to 60% by mass based on the whole composition (second aspect).
(3) The high-refractive-index resin composition according to (2) above wherein the particles have an average particle diameter of 10 nm or smaller.
(4) The high-refractive-index resin composition according to any one of (1) to (3) above wherein the polymerizable monomer is a (meth)acrylic monomer.
(5) The high-refractive-index resin composition according to any one of (1) to (4) above, wherein at least one surface-treating agent includes

a part (A) having at least one of adsorbability onto the particles and reactivity with the particles,

a part (B) which imparts compatibility with the polymerizable monomer to the coated particles, and

a part (C) having a high refractive index.

(6) The high-refractive-index resin composition according to (5) above, wherein the part (A) contains at least one of a group capable of forming ionic bond, a group capable of reacting with the particles to form covalent bond, a group capable of forming hydrogen bond, and a group capable of forming coordinate bond.
(7) The high-refractive-index resin composition according to (6) above, wherein the group capable of forming ionic bond comprises at least one of an acidic group or salt thereof and a basic group or salt thereof.
(8) The high-refractive-index resin composition according to (6) or (7) above, wherein the group capable of reacting with the particles to form covalent bond comprises at least one of —Si(OR¹)₃, —Ti(OR²)₃ (wherein R¹ and R² each represent a hydrogen atom, a hydrocarbon group having 1-25 carbon atoms, or an aromatic group), an isocyanate group, an epoxy group, an episulfide group, a hydroxyl group, a thiol group, a phosphine oxide, a carboxyl group, a phosphate group, and a phosphonate group.
(9) The high-refractive-index resin composition according to any one of (5) to (8) above, wherein the part (B) comprises at least one of a (meth)acryl group, a polyalkylene glycol group, and an aromatic group.
(10) The high-refractive-index resin composition according to any one of (5) to (9) above, wherein the part (C) is constituted of at least one sulfur atom and one aromatic ring and the surface-treating agent itself has a refractive index (n²⁵_{D}) of 1.55 or higher.
(11) The high-refractive-index resin composition according to any one of (1) to (10) above, wherein the particles are metal oxide.
(12) The high-refractive-index resin composition according to (11) above, wherein the metal oxide comprises at least one member selected from the group consisting of titanium oxide, zirconium oxide, and salts of titanic acid.
(13) The high-refractive-index resin composition according to any one of (1) to (12) above, wherein the polymerizable monomer comprises a polyfunctional (meth)acrylate compound represented by the following general formula (I) or general formula (II):

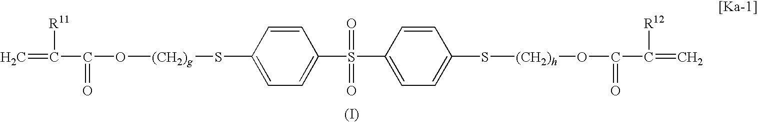

(wherein R¹¹ and R¹² each independently represent a hydrogen atom or a methyl group, and g and h each independently represent an integer of 1-6)

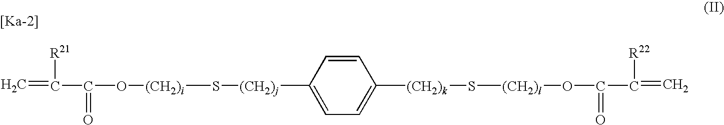

(wherein R²¹ and R²² each independently represent a hydrogen atom or a methyl group, and i, j, k, and l each independently represent an integer of 1-6).
(14) The high-refractive-index resin composition according to any one of (1) to (13) above which, when having a thickness of 2.0 mm, has a light transmittance of 80% or higher at 700 nm.
(15) An optical member comprising the high-refractive-index resin composition according to any one of (1) to (14) above.
(16) The optical member according to (15) above which is an optical part for imaging.
(17) The polymerizable composition as described under any one of (1) to (16) above.
(18) A polymerizable composition comprising: particles at least coated with a surface-treating agent and having an average particle diameter of 10 nm or smaller; and a polymerizable monomer, wherein at least one surface-treating agent includes a part (A) having at least one of adsorbability onto the particles and reactivity with the particles, a part (B) which imparts compatibility with the polymerizable monomer to the coated particles, and a part (C) having a high refractive index.
(19) The polymerizable composition according to (18) above wherein the polymerizable monomer is a (meth)acrylic monomer.
(20) The polymerizable composition according to (18) or (19) above wherein the content of the particles excluding the surface-treating agent is from 20% by mass to 60% by mass.
(21) The polymerizable composition according to any one of (18) to (20) above, wherein the part (A) contains at least one of a group capable of forming ionic bond, a group capable of reacting with the particles to form covalent bond, a group capable of forming hydrogen bond, and a group capable of forming coordinate bond.
(22) The polymerizable composition according to (21) above, wherein the group capable of forming ionic bond comprises at least one of an acidic group or salt thereof and a basic group or salt thereof.
(23) The polymerizable composition according to (21) or (22) above, wherein the group capable of reacting with the particles to form covalent bond comprises at least one of —Si(OR¹)₃, —Ti(OR²)₃ (wherein R¹ and R² each represent a hydrogen atom, a hydrocarbon group having 1-25 carbon atoms, or an aromatic group), an isocyanate group, an epoxy group, an episulfide group, a hydroxyl group, a thiol group, a phosphine oxide, a carboxyl group, a phosphate group, and a phosphonate group.
(24) The polymerizable composition according to any one of (18) to (23) above, wherein the part (B) comprises at least one of a (meth)acryl group, a polyalkylene glycol group, and an aromatic group.
(25) The polymerizable composition according to any one of (18) to (24) above, wherein the part (C) is constituted of at least one sulfur atom and one aromatic ring and the surface-treating agent itself has a refractive index (n²⁵_{D}) of 1.55 or higher.
(26) The polymerizable composition according to any one of (18) to (25) above, wherein the particles are metal oxide.
(27) The polymerizable composition according to (26) above,

wherein the metal oxide comprises at least one member selected from the group consisting of titanium oxide, zirconium oxide, and salts of titanic acid.

(28) The polymerizable composition according to any one of (18) to (27) above, wherein the polymerizable monomer comprises a polyfunctional (meth)acrylate compound represented by the following general formula (I) or general formula (II):

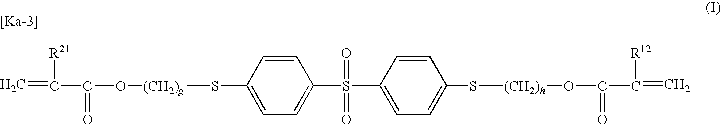

(wherein R¹¹ and R¹² each independently represent a hydrogen atom or a methyl group, and g and h each independently represent an integer of 1-6)

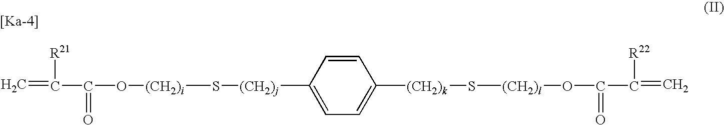

(wherein R²¹ and R²² each independently represent a hydrogen atom or a methyl group, and i, j, k, and l each independently represent an integer of 1-6).
(29) The polymerizable composition according to any one of (18) to (28) above which, when examined with a quartz cell having an optical path length of 2.0 mm, has a light transmittance of 80% or higher at 700 nm.
(30) The polymerizable composition according to any one of (18) to (29) above which contains a polymerization initiator.

### ADVANTAGES OF THE INVENTION

The resin composition containing high-refractive-index particles of the invention is transparent and can be used as an optical material having a high refractive index.

### BEST MODE FOR CARRYING OUT THE INVENTION

Embodiments of the invention are explained below in detail.

The high-refractive-index resin composition according to the first aspect of the invention is a high-refractive-index resin composition obtained by polymerizing a polymerizable composition containing particles coated with one or more surface-treating agents and having an average particle diameter of 10 nm or smaller, preferably 7 nm or smaller, and at least one polymerizable monomer, and is characterized in that the content of the particles excluding the surface-treating agents, X (% by mass), and the refractive index of the high-refractive-index resin composition, Y (n²³_{d}), have a relationship between these which is represented by the following general formula 1:

Y≧0.0035X+1.52

(wherein 20≦x≦60 and Y≦2.0).

In the region where Y<0.0035X+1.52 (20≦x≦60), the refractive index is low for the amount of the particles and, hence, particle addition to the resin offers no advantage. In addition, it is necessary to add the particles in an exceedingly large amount for increasing the refractive index and the resultant composition is expected to be difficult to handle because of, e.g., impaired flowability.

### (Particles)

Examples of the kinds of particles usable in the invention include oxides such as titanium oxide, zinc oxide, tin oxide, indium-tin oxide, antimony oxide, selenium oxide, cerium oxide, yttrium oxide, zirconium oxide, cerium oxide, CdO, PbO, HfO₂, and Sb₂O₅; titanic acid salts such as barium titanate, strontium titanate, potassium titanate, and calcium titanate; sulfides, selenides, and tellurides, such as CdS, CdSe, ZnSe, CdTe, ZnS, HgS, HgSe, PdS, and SbSe; and nitrides such as GaN. These materials may be used alone or as a mixture of two or more thereof.

It is also possible to use so-called core-shell type particles obtained by coating particles of one substance with another substance.

Preferred of those particulate materials are titanium oxide, zirconium oxide, and titanic acid salts. Especially preferred are titanium oxide and zirconium oxide.

For producing the particles of each compound to be used in the invention, various processes are usable. For example, in the case of TiO₂, the known process described in Journal of Chemical Engineering of Japan, Vol. 1, No. 1, pp. 21-28 (1998) can be used. In the case of ZnS, the known process described in Journal of Physical Chemistry, Vol. 100, pp. 468-471 (1996) can be used.

According to these processes, for example, titanium oxide having an average particle diameter of 5 nm can be easily produced by hydrolyzing Ti(OiPr)₄ (titanium tetraisopropoxide) or TiCl₄ as a raw material in an appropriate solvent. Furthermore, zinc sulfide having an average particle diameter of 40 nm can be produced by sulfurizing Zn(CH₃)₂ or zinc perchlorate as a raw material with hydrogen sulfide, sodium sulfide, or the like.

In the second aspect of the invention, particles having an average particle diameter of 1-100 nm can be used. By using particles having an average particle diameter reduced to 100 nm or smaller, a resin composition having excellent transparency can be prepared. The average particle diameter of the particles may be 100 nm or smaller and is preferably 50 nm or smaller, more preferably 30 nm or smaller, even more preferably 10 nm or smaller, especially preferably 7 nm or smaller.

These values of average particle diameter are ones determined by XRD (X-ray powder diffractometry) or through an examination with a transmission electron microscope or the like.

The refractive index (n²⁵_{D}) of the uncoated particles is generally 2.0-2.6 for TiO₂ or 1.8-2.2 for zirconium oxide, although it varies depending on the particle diameter thereof.

### (Surface-Treating Agents)

At least one of the surface-treating agents to be used in the invention may be one which includes a part (A) having adsorbability onto and/or reactivity with the particles, a part (B) which imparts compatibility with the polymerizable monomer to the coated particles, and a part (C) having a high refractive index.

The structural order of these three partial structures is not particularly limited unless the effects of the invention are lessened. Furthermore, one or more other partial structures (D) may have been incorporated in any desired positions so long as this does not influence the performances. Examples of such other partial structures (D) include hydrocarbon groups having about 1-20 carbon atoms and aromatic groups.

The following are examples of the structural sequence of (A) to (C).

1) (A)-(B)-(C)

2) (A)-(C)-(B)

3) (B)-(A)-(C)

The part (B), which imparts compatibility with the polymerizable monomer to the particles coated with the surface-treating agent (hereinafter sometimes referred to as compatibilizing group (B)), and the high-refractive-index part (C) may be ones possessed by one structure combining the two functions of (B) and (C). Examples of this structure include the following structure.

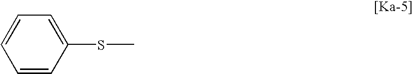

The structural sequence of (A), (B), and (C) more preferably is the structure 1) or 2), in which the part (A) having adsorbability and/or reactivity is present at an end.

The part having adsorbability means a group which is linked to a treated particle not by a covalent bond but by an ionic bond, chelate bond, or hydrogen bond. On the other hand, the part having reactivity means a group capable of forming a covalent bond with a treated particle.

As the part (A) having adsorbability and/or reactivity, use can be made of any of acidic groups, basic groups, reactive groups, a hydroxyl group, and a thiol group. Specifically, use can be made of any of acidic groups such as carboxylic acids, phosphoric acid, phosphoric esters, phosphorous esters, phosphonic acids, sulfonic acids, and sulfinic acids or salts of these acidic groups; basic groups such as amines or salts thereof; reactive groups such as —Si(OR¹)₃, —Ti(OR²)₃, an isocyanate group, an epoxy group, and an episulfide group; and a hydroxyl group, a thiol group, and a phosphine oxide. In the formulae, R¹ and R² each represent a hydrogen atom, a hydrocarbon group having 1-25 carbon atoms, or an aromatic group.

When the particle surface is basic, an acidic group is effective as the part (A) having adsorbability and/or reactivity. When the particle surface is acidic, a basic group is effective as the part (A).

As the part (B) having compatibility with the polymerizable monomer, use can be made of any of a (meth)acryl group, polyalkylene glycol groups, and aromatic groups (e.g., phenyl). Specifically, the polyalkylene glycol groups which can be used include a polyethylene glycol group and a polypropylene glycol group.

As the high-refractive-index part (C), use can be made of one which is constituted of at least one sulfur atom and one aromatic ring and enables the surface-treating agent itself to have a refractive index (n²⁵_{D}) of 1.51 or higher, more preferably 1.55 or higher.

The refractive index of the surface-treating agent itself to be used is preferably 1.51-1.8, more preferably 1.55-1.8. These values of refractive index herein mean ones measured at the wavelength of sodium D-line (wavelength, 589 nm) and a temperature of 25° C.

### EXAMPLES OF HIGH-REFRACTIVE-INDEX PART

Examples of the part (C) include the following structures.

### Example 1

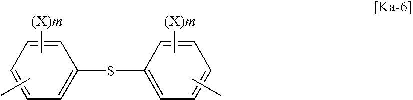

(In the formula, X represents hydrogen, an alkyl group having carbon atoms, or a halogen atom; and m is an integer of 1-4.)

### Example 2

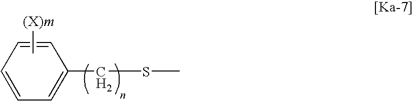

(In the formula, n is an integer of 0-4; X represents hydrogen, an alkyl group having 1-4 carbon atoms, or a halogen atom; and m is an integer of 1-4.)

### Example 3

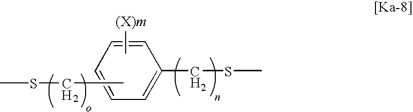

(In the formula, n and o each independently are an integer of 0-4; X represents hydrogen, an alkyl group having 1-4 carbon atoms, or a halogen atom; and m is an integer of 1-4.)

### Example 4

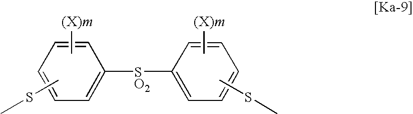

(In the formula, X represents hydrogen, an alkyl group having carbon atoms, or a halogen atom; and m is an integer of 1-4.)

### Example 5

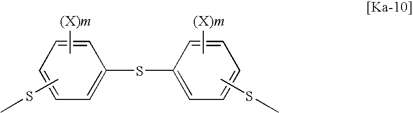

(In the formula, X represents hydrogen, an alkyl group having

1-4 carbon atoms, or a halogen atom; and m is an integer of 1-4.)

### EXAMPLES OF THE SURFACE-TREATING AGENT

Examples of specific compounds constituted of a combination of the parts (A) to (C) include the following compounds.

### Example 1

### (Phenylthio)acetic acid (S-phenylthioglycolic acid)

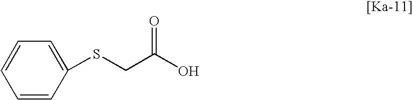

### Example 2

### Compound 1 represented by the following structural formula

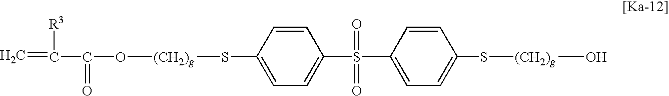

(In the formula, R³ represents a hydrogen atom or a methyl group; and g represents an integer of 1-6.)

### Example 3

### Compound 2 Represented by the Following Structural Formula

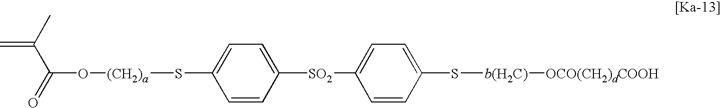

(In the formula, a, b, and d each independently represent an integer of 1-6.)

### Example 4

### Compound 3 Represented by the Following Structural Formula

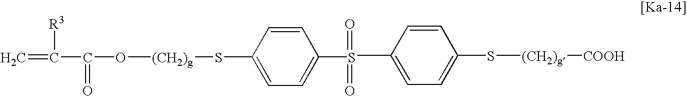

(In the formula, R³ represents a hydrogen atom or a methyl group; and g and g′ each independently represent an integer of 1-6.)

### Example 5

### Compound 4 Represented by the Following Structural Formula

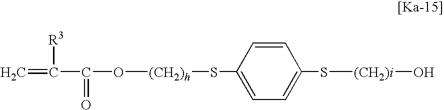

(In the formula, R³ represents a hydrogen atom or a methyl group; and h and i each independently represent an integer of 1-6.)

### Example 6

### Compound 5 Represented by the Following Structural Formula

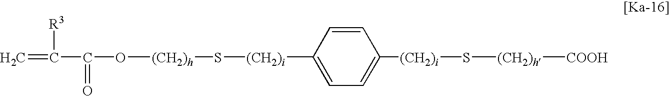

(In the formula, R³ represents a hydrogen atom or a methyl group; and h, h′, and i each independently represent an integer of 1-6.)

### (Other Surface-Treating Agents)

A combination of a surface-treating agent having the parts (A), (B), and (C) with one or more other surface-treating agents may be used as the surface-treating agents in the invention for the purpose of improving dispersibility, etc. Examples of dispersants containing no sulfur atom include phosphonic acids such as phenylphosphonic acid, phosphoric acid compounds such as phenylphosphoric acid, sulfonic acids such as phenylsulfonic acid and p-toluenesulfonic acid, carboxylic acids such as benzoic acid, phenylpropionic acid, diphenylacetic acid, 4-phenylbenzoic acid, phthalic acid, phenylsuccinic acid, and phenylmalonic acid, and silane coupling agents such as phenyltriethoxysilane, phenyltrimethoxy silane, diphenyldiethoxysilane, and diphenyldimethoxysilane.

### (Method of Particle Surface Treatment)

For treating the surface of particles with a surface-treating agent, a solvent mixing method is generally used. Specifically, particles whose surface has been treated can be obtained, for example, by preparing a solvent dispersion of particles and a solution of a surface-treating agent and mixing the two liquids together, or by adding a surface-treating agent to a solvent dispersion of particles.

As the dispersion solvent for dispersing the particles therein, use may be made of water and alcohols such as methanol, ethanol, isopropanol, and n-butanol; polyhydric alcohols such as ethylene glycol and derivatives thereof; ketones such as methyl ethyl ketone, methyl isobutyl ketone, cyclohexanone, and dimethyldimethylacetamide; ethers such as dimethyl ether and THF; esters such as ethyl acetate and butyl acetate; nonpolar solvents such as toluene and xylene; acrylates such as 2-hydroxybutyl acrylate, 2-hydroxypropyl acrylate, and 4-hydroxybutyl acrylate; and other general organic solvents. The amount of the dispersion solvent is generally 100-5,000 parts by mass, preferably 100-2,000 parts by mass, per 100 parts by mass of the particles.

According to need, a known dispersant may also be used, such as a polycarboxylic acid type dispersant, silane coupling agent, titanate coupling agent, silicone dispersant, e.g., a modified silicone oil, or organic copolymer type dispersant.

The particles thus obtained may be used without being subjected to any treatment, or may be used after having been purified by reprecipitation purification, film purification, or another method.

Concentration and pH at the time of mixing and the time period of mixing can be selected at will within ranges in ordinary use.

The amount ratio between the particles and the surface-treating agent can be selected at will so that the particle/surface-treating agent ratio is in the range of from 1/0.01 to 1/10. Use of the surface-treating agent in a large amount results in a decrease in refractive index. Consequently, that ratio is usually in the range of about from 1/0.01 to 1/2, preferably from 1/0.01 to 1.

The high-refractive-index particles according to the invention are mixed with at least one polymerizable monomer, preferably at least one high-refractive-index monomer, and this mixture is formed into a molded article through curing with a light, e.g., UV, or thermal curing. This mold article is used as a high-refractive-index resin composition.

(Polymerizable Monomer)

The polymerizable monomer in the invention is not particularly limited. Polymerizable monomers in which the particles can be dispersed are usable without particular limitations. Examples thereof include photocurable monomers or oligomers, composites of these, heat-curable monomers or oligomers, and compositions of these. The polymerizable monomer preferably is a photocurable monomer. More preferred examples thereof include (meth)acrylate monomers. The term (meth)acrylate in the invention includes methacrylate and acrylate.

(Examples of the Polymerizable Monomer)

Examples of the (meth)acrylic monomers include monofunctional (meth)acrylate compounds having one (meth)acryloyl group in the molecule and polyfunctional (meth)acrylate compounds having two or more (meth)acryloyl groups.

Examples of the monofunctional methacrylate compounds include methyl (meth)acrylate, ethyl (meth)acrylate, n-butyl (meth)acrylate, isobutyl (meth)acrylate, t-butyl (meth)acrylate, 2-ethylhexyl (meth)acrylate, lauryl (meth)acrylate, stearyl (meth)acrylate, cyclohexyl (meth)acrylate, 2-hydroxyethyl (meth)acrylate, 2-hydroxypropyl (meth)acrylate, 2-hydroxybutyl (meth)acrylate, 4-hydroxybutyl (meth)acrylate, glycidyl (meth)acrylate, tetrahydrofurfuryl (meth)acrylate, phenylglycidyl (meth)acrylate, dimethylaminomethyl (meth)acrylate, phenyl Cellosolve (meth)acrylate, dicyclopentenyl (meth)acrylate, biphenyl (meth)acrylate, 2-hydroxyethyl (meth)acryloylphosphate, phenyl (meth)acrylate, phenoxyethyl (meth)acrylate, phenoxypropyl (meth)acrylate, benzyl (meth)acrylate, cyclohexyl (meth)acrylate, 2-benzylthioethyl (meth)acrylate, and benzyl (meth)acrylate.

Examples of the polyfunctional monomers include ethylene glycol di(meth)acrylate, diethylene glycol di(meth)acrylate, triethylene glycol di(meth)acrylate, tetraethylene glycol di(meth)acrylate, nonaethylene glycol di(meth)acrylate, 1,3-butylene glycol di(meth)acrylate, 1,4-butanediol di(meth)acrylate, trimethylolpropane tri(meth)acrylate, neopentyl glycol di(meth)acrylate, 1,6-hexamethylene di(meth)acrylate, hydroxypivalic esters neopentyl glycol di(meth)acrylate, pentaerythritol tri(meth)acrylate, pentaerythritol tetra(meth)acrylate, dipentaerythritol hexa(meth)acrylate, tris(meth)acryloxyethyl isocyanurate, and bis(hydroxy)tricyclo[5.2.1.0^{2,6}]decane di(meth)acrylate.

Monomers other than (meth) acrylic monomers may be mixed so long as this does not impair compatibility. Examples of the mixable monomers include styrene compounds, (meth) acrylic acid derivatives, (meth)acrylic acid, and N-vinylamide compounds.

Examples of the styrene compounds include styrene, chlorostyrene, vinyltoluene, 1-vinylnaphthalene, 2-vinylnaphthalene, divinylbenzene, and α-methylstyrene.

Examples of the (meth) acrylic acid derivatives include acrylamide, methacrylamide, acrylonitrile, and methacrylonitrile.

Examples of the N-vinylamide compounds include N-vinylpyrrolidone, N-vinylcaprolactam, N-vinylacetamide, and N-vinylformamide.

Preferred of those polymerizable monomers are high-refractive-index monomers.

(High-Refractive-Index Monomer)

The term high-refractive-index monomer means a monomer having a refractive index (n²⁵_{D}) of generally 1.55 or higher, preferably 1.57 or higher. Examples of high-refractive-index (meth)acrylic monomers include polyfunctional (meth)acrylate compounds having two or more (meth)acryloyl groups in the molecule and represented by the following general formula (I) or general formula (II).

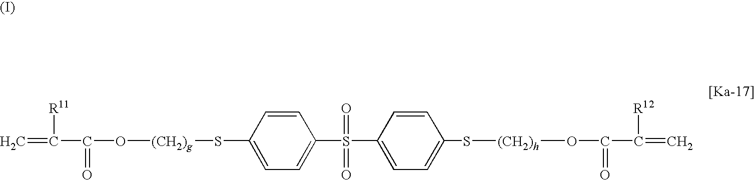

(In the formula, R¹¹ and R¹² each independently represent a hydrogen atom or a methyl group; and g and h each independently represent an integer of 1-6.)

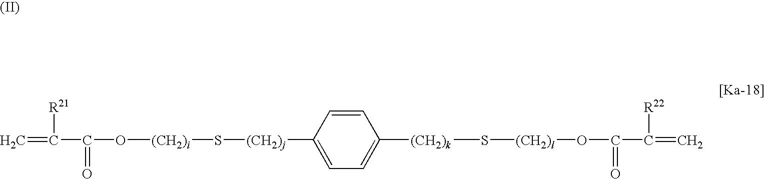

(In the formula, R²¹ and R²² each independently represent a hydrogen atom or a methyl group; and i, j, k, and l each independently represent an integer of 1-6.)

Examples of high-refractive-index monomers further include bis(4-methacryloylthiophenyl) sulfide (hereinafter referred to as MPSMA). This monomer has a melting point of 64° C. and is hence solid at room temperature. It is therefore preferred to use this monomer in the form of a solution in a polymerizable monomer which is liquid at room temperature.

In preparing the polymerizable composition according to the invention, two or more of those polymerizable monomers may be used in combination for the purpose of regulating properties.

### (Process for Producing the Polymerizable Composition)

For producing the polymerizable composition containing particles whose surface has been treated, use may be made of a process in which the particles whose surface has been treated are mixed with a polymerizable monomer. Examples of the process include: a method in which a solution of the particles is mixed with a solution of a polymerizable monomer, and the solvent is then removed; a method in which a polymerizable monomer is added to a solution containing the particles dispersed therein, and the solvent is then removed; and a method in which a polymerizable monomer is added simultaneously with the addition of the surface-treating agent to a dispersion of the particles, and the solvent is then removed. An evaporator is suitable for use in the solvent removal. In the case where the particles include aggregates, the dispersion or mixture may be suitably subjected to a dispersing treatment.

As the dispersing treatment, use may be made of any of dispersing operations such as a dispersing treatment with an ultrasonic disperser and a dispersing operation with a bead mill, paint shaker, or the like.

There also is a method in which the particles are mixed with a polymerizable monomer without using any solvent for the mixing and the resultant mixture is directly subjected to a dispersing operation. In each method, whether a solvent is used or not and the timing of solvent removal can be suitably selected. Methods for mixing the particles with a polymerizable monomer are not limited to this method, and any method is effective.

The amount of the particles in the composition may be from 20% by mass to 60% by mass, especially preferably from 30% by mass to 50% by mass, in terms of the content of the particles excluding the surface-treating agents. In case where the amount of the particles is too small, the increase in refractive index is small and it is therefore difficult to obtain a resin composition having a high refractive index. In case where the amount of the particles added is too large, the polymerizable composition has reduced flowability and is difficult to mold. The amount of the particles excluding the surface-treating agents may be calculated from feed amount ratio. Alternatively, the amount thereof can be obtained by a technique in which the polymerizable composition obtained is subjected to TG-DTA or the like to remove organic matters therefrom (thermogravimetric analysis) or by elemental analysis.

In the invention, the amount of the polymerizable monomer in the polymerizable composition is generally 20-80% by mass, especially preferably 30-70% by mass. In case where the amount of the polymerizable monomer is too small, there is a problem that the resin composition obtained is brittle. In case where the amount of the polymerizable monomer is too large, a resin composition having a high refractive index is not obtained.

The polymerizable composition of the invention has excellent transparency. When examined with a quartz cell having an optical path length of 2.0 mm, the composition has a light transmittance at 700 nm of generally 80% or higher, preferably 85% or higher, even more preferably 90% or higher. In case where the light transmittance thereof is too low, the resin composition obtained has a reduced transmittance and is difficult to use as an optical member.

The polymerizable composition has a viscosity of mPa·s, more preferably 100-50,000 mPa·s, at 30° C. Too high viscosities result in difficulties in pouring the composition into a mold in molding. In case where the viscosity of the composition is too low, there is a possibility that the composition might penetrate into mold gaps to arouse a trouble in a later step. Too low viscosities hence may pose a problem.

<Process for Producing Resin Composition>

### (Initiator)

The resin composition is obtained generally by incorporating a polymerization initiator into the polymerizable composition and curing the resultant mixture.

Examples of the polymerization initiator include photopolymerization initiators which generate a radical upon irradiation with actinic energy rays, e.g., ultraviolet or visible light, and heat polymerization initiators which generate a radical upon heating. Usually, a photopolymerization initiator or a combination of a photopolymerization initiator and a heat polymerization initiator is used.

As the photopolymerization initiator, compounds known to be usable in this application can be used. Examples thereof include benzophenone, benzoin methyl ether, benzoin propyl ether, diethoxyacetophenone, 1-hydroxycyclohexyl phenyl ketone, 2,6-dimethylbenzoyldiphenylphosphine oxide, and 2,4,6-trimethylbenzoyldiphenylphosphine oxide. Preferred of these is 2,4,6-trimethylbenzoyldiphenylphosphine oxide. These photopolymerization initiators may be used alone or in combination of two or more thereof.

The photopolymerization initiator may be used in an amount of generally 0.001 part by mass or larger, preferably 0.02 parts by mass or larger, more preferably 0.05 parts by mass or larger, per 100 parts by mass of all radical-polymerizable compounds in the polymerizable resin composition. The upper limit of the amount thereof is generally 5 parts by mass or smaller, preferably 3 parts by mass or smaller, more preferably 1 part by mass or smaller. In case where the photopolymerization initiator is added in too large an amount, there is a possibility that polymerization might proceed excessively rapidly to give a cured object which not only has enhanced birefringence but has an impaired hue. On the other hand, too small amounts thereof may result in a possibility that polymerization of the composition might be insufficient.

As the heat polymerization initiator, compounds known to be usable in this application can be used. Examples thereof include hydroperoxide and hydroperoxides in which one of the hydrogen atoms has been replaced by a hydrocarbon group, such as t-butyl hydroperoxide, diisopropylbenzene hydroperoxide, and 1,1,3,3-tetramethylbutyl hydroperoxide, dialkyl peroxides such as di-t-butyl peroxide and dicumyl peroxide, peroxyesters such as t-butyl peroxybenzoate and t-butyl peroxy(2-ethylhexanoate), diacyl peroxides such as benzoyl peroxide, peroxycarbonates such as diisopropyl peroxycarbonate, and peroxides such as peroxyketals and ketone peroxides.

Preferred of these are dicumyl peroxide, di-t-butyl peroxide, t-butyl peroxybenzoate, t-butyl hydroperoxide, and the like. These polymerization initiators may be used alone or in combination of two or more thereof.

The heat polymerization initiator may be used in an amount of generally 0.1 part by mass or larger, preferably 0.5 parts by mass or larger, more preferably 0.8 parts by mass or larger, based on all radical-polymerizable compounds in the polymerizable resin composition. The upper limit of the amount thereof is generally 10 parts by mass or smaller, preferably 5 parts by mass or smaller, more preferably 2 parts by mass or smaller. In case where the heat polymerization initiator is added in too large an amount, there is a possibility that polymerization might proceed too rapidly when the polymerizable composition is thermally polymerized after photopolymerization in a mold and subsequent demolding, resulting in a resin molding which not only has enhanced birefringence but has an impaired hue. On the other hand, too small amounts thereof may result in a possibility that heat polymerization might proceed insufficiently.

In the case where a photopolymerization initiator and a heat polymerization initiator are used in combination, the mass ratio between these is generally 1/(1-100), preferably 1/(2-20). In case where the proportion of the heat polymerization initiator is too small, polymerization might be insufficient. Too large proportions thereof result in a possibility of coloring.

The polymerizable composition to be used in the invention may contain ingredients other than those described above, so long as this does not impair the properties of the resin molding to be obtained. Examples of such ingredients include radical-polymerizable compounds in the polymerizable resin composition, chain transfer agents, silane coupling agents, antioxidants, ultraviolet absorbers, ultraviolet stabilizers, dyes and pigments, fillers, and release agents. There also are cases where the polymerizable composition contains a slight amount of a solvent or water remaining unremoved.

(Molding Method)

The high-refractive-index resin composition containing particles according to the invention can be used to obtain an optical material. Examples of methods therefor include a method in which the high-refractive-index resin composition is produced by molding through photocuring with, e.g., UV or thermal curing.

(Photocuring)

A resin composition according to the invention can be obtained by injecting the polymerizable composition described above into a mold at least one side of which is made of a light-transmitting material, irradiating the polymerizable composition with a light to cure the composition, and then releasing the cured composition from the mold. Although a resin having satisfactory transparency may be used as the light-transmitting material, it is generally preferred to use glass so that the material is prevented from being deteriorated or deformed by light irradiation. The cavity depth of the mold (i.e., the thickness of the resin molding to be formed) is generally 10 mm or smaller, preferably 5 mm or smaller, and is generally 50 μm or larger, preferably 200 μm or larger. In case where the thickness of the resin molding is too small, this molding has low mechanical strength and is difficult to form by the method according to the invention. In case where the cavity depth is too large, an isotropic molding is not obtained because a strain generates during molding.

The light with which the polymerizable composition is to be irradiated has a wavelength of 100-800 nm, preferably 200-600 nm, more preferably 200-500 nm, although the wavelength thereof depends on the absorption wavelength for the photopolymerization initiator, etc. Too short wavelengths may result in accelerated resin deterioration. Too long wavelengths may result in cases where the photopolymerization initiator does not absorb the light.

Any desired light irradiation dose may be used so long as it is within a range where the photopolymerization initiator generates a radical. However, in case where the dose of ultraviolet irradiation is too small, polymerization is insufficient and the resin composition obtained has insufficient heat resistance and insufficient mechanical properties. On the other hand, in case where the dose thereof is too large, the resultant resin composition has suffered deterioration by light, such as yellowing. It is therefore preferred to irradiate the polymerizable composition under the conditions of an irradiance of 10-5,000 mW/cm², time period of from 0.1 second to 30 minutes, and irradiation dose of 0.01-10,000 J/cm². By portion-wise conducting ultraviolet irradiation in two or more times, a resin molding reduced in birefringence can be obtained. Examples of ultraviolet sources include a metal halide lamp, high-pressure mercury lamp, electrodeless mercury lamp, and LED. Photopolymerization and heat polymerization may be simultaneously conducted for the purpose of speedily completing the polymerization.

The resin composition obtained by light irradiation may be further heated. By this heating, the polymerization reaction can be completely carried out and the internal strains which have generated during the polymerization can be diminished. A heating temperature is suitably selected according to the composition and glass transition temperature of the cured object. However, the temperature is generally around or below the glass transition temperature, preferably 50° C.-250° C. The period of heating may be from 1 minute to 1 week and is preferably from 30 minutes to 3 days, more preferably from 1 hour to 1 day. In case where the heating temperature is too high or the heating period is too long, there is a possibility that a resin molding having an impaired hue might be obtained. The heating may be conducted in an atmosphere such as air or an inert gas, e.g., nitrogen or argon, or under vacuum. It is preferred that the heating should be conducted after demolding.

The resin composition thus obtained according to the invention contains evenly dispersed particles and has no optical orientation.

The refractive index (n²³_{d}) of the resin composition may be 1.66 or higher and is preferably 1.7 or higher, especially preferably 1.75 or higher. Although the upper limit of the refractive index thereof is not particularly limited, it is generally about 2.0 or lower. These values of the refractive index (n²³_{d}) of the resin composition mean ones measured at the wavelength of d-line (587.6 nm) and a temperature of 23° C.

The amount of the particles in the resin composition may be from 20% by mass to 60% by mass, especially preferably from 30% by mass to 50% by mass, in terms of the content of the particles excluding the surface-treating agents, as in the polymerizable composition described above. In case where the amount of the particles is too small, the increase in refractive index is small and it is therefore difficult to obtain a resin composition having a high refractive index. In case where the amount of the particles added is too large, the polymerizable composition before curing has reduced flowability and is difficult to mold. The amount of the particles excluding the surface-treating agents may be calculated from feed amount ratio. Alternatively, the amount thereof can be obtained by a technique in which the resin composition obtained is subjected to TG-DTA or the like to remove organic matters therefrom (thermogravimetric analysis) or by elemental analysis.

The total light transmittance of the resin composition having a thickness of 1.0 mm may be 70% or higher, especially 75% or higher. Although the resin composition contains particles, it has a high light transmittance.

When the resin composition has a thickness of 2.0 mm, it may have a light transmittance at 700 nm of 80% or higher. The light transmittance at 700 nm thereof is preferably 83% or higher, more preferably 85% or higher. In case where the light transmittance thereof is too low, there is a problem that this resin composition has low transparency and is hence difficult to use as an optical member.

The resin composition, when examined at 25° C. with a birefringence measuring apparatus manufactured by ORC Manufacturing Co., Ltd., has a birefringence as small as generally 10 nm or below, especially 5 nm or below. The resin composition is optically homogeneous. The resin composition has a pencil hardness of generally 2B-4H, preferably B-4H. The resin composition has a Tg (glass transition temperature) of generally 70° C. or higher, preferably 100° C. or higher.

### (Optical Member)

The resin composition of the invention can be used as a coating material for optical use, hard-coating material, or optical member. Preferred of these is an optical member. Examples of the optical member include optical lenses, optical films, optical filters, optical sheets, optical thin films, lightguide plates, optical waveguides, and optical parts for imaging. Preferred of these are optical parts for imaging.

An explanation is given on optical lenses as an example of the optical parts for imaging. As can be easily understood, the resin composition of the invention has the merit of being capable of reducing the overall length of an optical system, i.e., reducing the size, because of the high refractive index thereof. The resin composition of the invention is moldable by cast molding. Consequently, after molds are produced, the resin composition can be molded into shapes regardless of whether the shapes have a spherical or aspherical surface. The shapes of the optical lenses also are not limited, and may be a biconvex, biconcave, or meniscus lens or the like. These optical lenses can be extensively used in the imaging parts of still cameras, digital cameras, optical pickups, video cameras for portable information terminals, etc., and in projectors, various measuring instruments, traffic signals, etc.

### EXAMPLES

The invention will be further explained below by reference to Synthesis Examples, Examples, and Comparative Examples.

### (Method of Measuring Refractive Index of Surface-Treating Agent/Polymerizable Composition)

The refractive index of each surface-treating agent/polymerizable composition was measured with Abbe refractometer DR-M2, manufactured by ATAGO Co., Ltd., equipped with a thermostatic bath containing water circulated at 25° C. A light having the wavelength of sodium D-line (wavelength, 589 nm) was used to measure the refractive index (n²⁵_{D}).

### (Method of Judging Transparency of Resin Composition)

Resin compositions obtained (thickness, 2 mm) were visually judged. The compositions having no turbidity were judged to have satisfactory compatibility.

### (Method of Determining Transmittance Spectrum of Polymerizable Composition/Resin Composition)

Polymerizable compositions/resin compositions were examined for transmittance spectrum at room temperature with spectrophotometer for ultraviolet and visible region Type 8453, manufactured by Hewlett-Packard Co. (current name: Agilent Technologies, Inc.). Each polymerizable composition was placed in a quartz cell having an optical path length of 2.0 mm and examined using air as a blank. Each resin composition in a plate form having a thickness of 2.0 mm was examined using air as a blank.

### (Method of Measuring Refractive Index of Resin Composition (Cured Object))

Precision refractometer KPR-2, manufactured by Kalnew Co., Ltd., equipped with a thermostatic bath containing water circulated at 23° C. was used for the measurement. A light (d-line) having a wavelength of 587.6 nm was used to measure the refractive index (n²³_{d}).

### (Method of Determining Particle Amount by Thermogravimetric Analysis (TG))

TG-DTA 320, manufactured by Seiko Instruments Inc. (current name: SII Nano Technology Inc.) was used to make a measurement on an aluminum dish in a 200 mL/min air stream. With respect to heating conditions, a sample was heated from room temperature to 600° C. (actual temperature beneath the sample, about 595° C.) at a set heating rate of 10° C./min. The value obtained by subtracting the resultant loss from the initial amount was taken as the amount of particles. Thus, the proportion (% by mass) of particles in each polymerizable composition or resin composition was calculated.

In the case of determining the proportion of the particles to the surface-treating agent, the following conditions were used. The heating rate was set at 10° C./min, and the treated particles were heated from room temperature to a set temperature of 140° C. (actual temperature beneath the sample, about 130° C.). The particles were held at that temperature for 30 minutes and then heated to a set temperature of 600° C. (actual temperature beneath the sample, about 595° C.). The loss caused at the temperatures of 130° C. and lower was taken as a loss assigned to the removal of the solvent and the like, while the loss caused at the temperatures of from 130° C. to 600° C. was taken as the amount of organic matters (mainly the surface-treating agent) in the particles. In the case where the removal of the organic matters was incomplete at 600° C., a dish made of platinum was used to heat the sample to a set temperature of 700° C.

### (Determination of X-Ray Powder Diffraction (XRD) Pattern and Calculation of Particle Diameter (Crystallite Size))

An X-ray powder diffraction pattern was determined with PW1700, manufactured by PANalytical (former name: Philips), Holland. The examination conditions included the following: X-ray output (CuKα), 40 kW and 30 mA; scanning axis, 0/20; scanning range (2θ), 5.0-80.00; examination mode, continuous; read width, 0.05°; scanning rate, 3.0°/min; and slits, DS: 1°, SS: 1°, and RS: 0.2 mm.

Crystallite size (D) was calculated using the Scherrer equation represented by the following expression (1). Incidentally, the Scherrer constant (K) was taken as 0.9, and the wavelength (λ) of the X-ray (CuKα1) was taken as 1.54056 Å. The Bragg angle (θ) assigned to CuKα1 line and the half-value width (30) assigned to CuKα1 line were calculated by the profile fitting method (Peason-VII function) using JADE 5.0+, manufactured by MDI Corp. That half-value width (β) for the sample which was assigned to CuKα1 and used in the calculation was corrected using expression (2), which included β1 calculated from a regression curve concerning the diffraction angle (20) assigned to CuKα1 determined beforehand with standard silicon and that half-value width for the apparatus which was assigned to CuKα1 line.

Scherrel equation

D=K·λ/β·cos θ expression (1)

Equation for correcting half-value width

β=(β0²−βi²)^{1/2} (expression 2)

### Synthesis Example 1

### (Synthesis of Titanium Oxide Particles)

The inside of a 300-mL three-necked flask was washed with concentrated hydrochloric acid three times. Subsequently, 100 mL of desalted water was introduced into the flask. The system was degassed with nitrogen. Four milliliters of concentrated hydrochloric acid was introduced thereinto, and this flask was put on an ice bath to keep the temperature of the contents at 10° C. or lower. Four milliliters of TiCl₄ was added dropwise thereto with a syringe at a rate of 2 mL/min. The solution obtained was stirred at 10° C. or lower for 10 minutes. Thereafter, the flask was transferred to an oil bath and the contents were stirred at 60° C. for 1 hour to obtain a titanium oxide particle solution. Using a vacuum pump, the water was removed from this solution under vacuum. THF/EtOH (1:1 mixture) solution was added to the resultant white powder, and an ultrasonic wave was propagated to the resultant mixture with an ultrasonic washer. Thus, transparent 10% by mass titanium oxide particle solution A was obtained. The diameter of the titanium oxide particles was determined by XRD (X-ray powder diffractometry). As a result, the diameter thereof was found to be 3 nm.

### Synthesis Example 2

### Synthesis of Surface-Treating Agent 1

Into a 1-L four-necked flask equipped with a stirrer, thermometer, condenser, and separator were introduced 4,4′-bis(2-hydroxyethylthio)diphenyl sulfone (100 g), methyl methacrylate (Tokyo Kasei Kogyo Co., Ltd.; 270 g), hydroquinone monomethyl ether (Tokyo Kasei Kogyo Co., Ltd.; 0.137 g), and toluene (Kanto Chemical Co., Ltd.; 200 g). The contents were heated to 80° C. with stirring. Thereto was added tetrabutyl titanate (Tokyo Kasei Kogyo Co., Ltd.; 2.8 g). The resultant mixture was further heated and reacted at 100-120° C. for 8 hours while distilling off methanol. After the reaction, the excess methyl methacrylate was removed and the resultant reaction solution was cooled to room temperature. To this solution was added 100 g of toluene. The resultant mixture was washed with 150 g of 5% aqueous hydrochloric acid solution and then with 150 g of 5% aqueous sodium hydroxide solution, and further washed with 150 g of water three times until the washings became neutral. To this solution was added 0.135 g of hydroquinone monomethyl ether. The toluene was distilled off under reduced pressure to obtain a crude product. The crude product was purified by silica gel chromatography using an n-hexane/ethyl acetate system. Thus, surface-treating agent 1 (32.4 g) represented by the following formula was obtained. Surface-treating agent 1 had a refractive index (n²⁵_{D}) of 1.64.

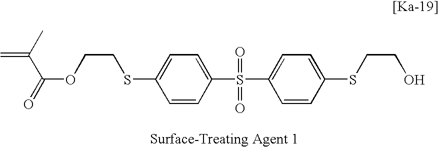

### Synthesis Example 3

### Synthesis of Surface-Treating Agent 2

Surface-treating agent 1 (32.4 g) was placed in a flask. A solution of succinic anhydride (Tokyo Kasei Kogyo Co., Ltd.; 7.75 g) and triethylamine (Kanto Chemical Co., Inc.; 0.746 g) in acetone (Kanto Chemical Co., Inc.; 30 g) was added to and mixed with the surface-treating agent. This mixture was stirred at 60° C. for 3 hours. Thereafter, the mixture was washed with 150 g of 5% aqueous hydrochloric acid solution once and then with 150 g of water three times. Subsequently, the mixture was dried with magnesium sulfate and then vacuum-dried. Thus, surface-treating agent 2 (27.5 g) represented by the following formula was obtained. Surface-treatin gagent 2 had a refractive index (n²⁵_{D}) of 1.60.

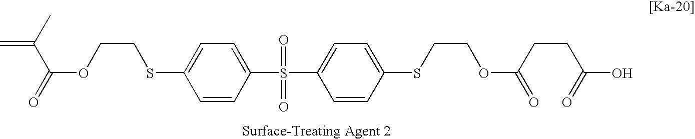

### Synthesis Example 4

### Synthesis of Surface-Treating Agent 3

The same procedure as in Synthesis Example 2 was conducted, except that 2,2′-[p-phenylenebis(methylenethio)]diethanol (236.3 g) was used in place of the 4,4′-bis(2-hydroxyethylthio)diphenyl sulfone (100 g) in Synthesis Example 2. Thus, surface-treating agent 3 (18.9 g) represented by the following formula was obtained. Surface-treating agent 3 had a refractive index (n²⁵_{D}) of 1.58.

Surface-Treating Agent 3

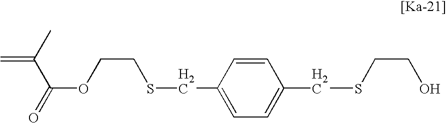

### Synthesis Example 5

### Synthesis of Surface-Treating Agent 4

The same procedure as in Synthesis Example 3 was conducted, except that surface-treating agent 3 (18.9 g) was used in place of the surface-treating agent 1 (32.4 g) in Synthesis Example 3. Thus, surface-treating agent 4 (16.5 g) represented by the following formula was obtained. Surface-treating agent 4 had a refractive index (n²⁵_{D}) of 1.54.

Surface-Treating Agent 4

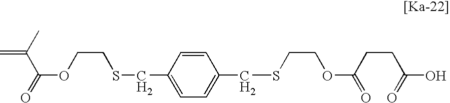

### Synthesis Example 6

### Synthesis of Surface-Treating Agent 5

The same procedure as in Synthesis Example 2 was conducted, except that benzyl chloride (Tokyo Kasei Kogyo Co., Ltd.; 500 g) was used in place of the 4,4′-bis(2-hydroxyethylthio)diphenyl sulfone (100 g) in Synthesis Example 2. Thus, surface-treating agent 5 (640 g) represented by the following formula was obtained. Surface-treating agent 5 had a refractive index (n²⁵_{D}) of 1.57.

Surface-Treating Agent 5

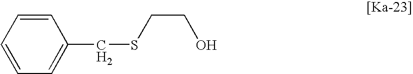

### Synthesis Example 7

### Synthesis of Surface-Treating Agent 6

The same procedure as in Synthesis Example 3 was conducted, except that surface-treating agent 5 (100 g) was used in place of the surface-treating agent 1 (32.4 g) in Synthesis Example 3. Thus, surface-treating agent 6 (70 g) represented by the following formula was obtained. Surface-treating agent had a refractive index (n²⁵_{D}) of 1.54.

Surface-Treating Agent 6

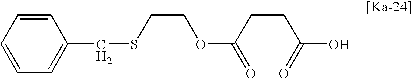

### Synthesis Example 8

### Synthesis of Surface-Treating Agent 7

Into a flask were introduced the surface-treating agent 6 (7.03 g) synthesized in Synthesis Example 7 and triphenylphosphine (Tokyo Kasei Kogyo Co., Ltd.; 16.43 g). The atmosphere in the vessel was replaced with nitrogen. Thereafter, dry tetrahydrofuran (hereinafter abbreviated to THF; 100 mL) was added thereto in a nitrogen stream to completely dissolve the contents. This flask was transferred onto an ice bath, and carbon tetrabromide (Tokyo Kasei Kogyo Co., Ltd.; 20.77 g) was added little by little thereto with stirring in a nitrogen stream. Thereafter, the mixture was stirred at room temperature for 3 hours. This reaction mixture was concentrated under vacuum, and the resultant concentrate was subjected to vacuum filtration. The solid remaining on the filter paper was washed with n-hexane (Junsei Chemical Co., Ltd.; 50 mL) twice. The filtrate and the washings were put together, and the resultant mixture was concentrated under vacuum to obtain a crude product. The crude product was purified by silica gel chromatography using an n-hexane/ethyl acetate system to obtain 2-(benzylthio)ethyl bromide (6.56 g).

The 2-(benzylthio)ethyl bromide (6.56 g) was introduced into a flask, and the atmosphere in the vessel was replaced with nitrogen. Thereafter, tris(trimethylsilyl) phosphite (Tokyo Kasei Kogyo Co., Ltd.; 25.42 g) was added to and mixed with the bromide in a nitrogen stream. The mixture was stirred at 120° C. for 11 hours and then cooled to 85° C. with stirring. The excess tris(trimethylsilyl) phosphite was removed under vacuum, and after the amount of the reaction mixture came not to decrease any more, the reaction mixture was cooled to room temperature. The pressure in the vessel was returned to ordinary pressure with nitrogen. Thereafter, THF/water=100/1 (volume ratio) (20.2 mL) was added to the reaction mixture, and the contents were stirred at room temperature for 3 hours. The resultant reaction mixture was concentrated under vacuum, and ethanol was added to the residue to dissolve it. Vacuum concentration was conducted again. Chloroform was added to the residue to dissolve it, and the solution obtained was passed through a silica gel column. This column was washed with chloroform. The solution which had been passed through the column and the washings were put together, concentrated under vacuum, and vacuum-dried at room temperature (3.5 g). Surface-treating agent 7 is expected to have a refractive index (n²⁵_{D}) of 1.54.

Surface-Treating Agent 7

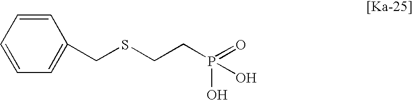

### Synthesis Example 9

### Production of Titanium Oxide Particles Coated with (Phenylthio)Acetic Acid

Three grams of commercial (phenylthio)acetic acid (S-phenylthioglycolic acid) (manufactured by Tokyo Kasei Kogyo Co., Ltd.) was dissolved in 27 g of THF to obtain a 10% by mass solution of (phenylthio)acetic acid. Seventy grams of the 10% by mass titanium oxide particle solution A obtained in Synthesis Example 1 was gradually added dropwise to that solution to obtain transparent solution A of coated titanium oxide particles. The amount of the surface-treating agent in the coated titanium oxide particles was 30% by mass.

### Synthesis Example 10

### Production of Titanium Oxide Particles Coated with Surface-Treating Agent 1

The same procedure as in Synthesis Example 9 was conducted, except that the (phenylthio)acetic acid was replaced by surface-treating agent 1. As a result, transparent solution B of coated titanium oxide particles was obtained. The amount of the surface-treating agent in the coated titanium oxide particles was 30% by mass.

### Synthesis Example 11

### Production of Particles Coated with Surface-Treating Agent 2

The same procedure as in Synthesis Example 9 was conducted, except that the (phenylthio)acetic acid was replaced by surface-treating agent 2. As a result, transparent solution C of coated titanium oxide particles was obtained. The amount of the surface-treating agent in the coated titanium oxide particles was 30% by mass.

### Synthesis Example 12

### Production of Particles Coated with Surface-Treating Agent 3

The same procedure as in Synthesis Example 9 was conducted, except that the (phenylthio)acetic acid was replaced by surface-treating agent 3. As a result, transparent solution D of coated titanium oxide particles was obtained. The amount of the surface-treating agent in the coated titanium oxide particles was 30% by mass.

### Synthesis Example 13

### Production of Particles Coated with Surface-Treating Agent 4

The same procedure as in Synthesis Example 9 was conducted, except that the (phenylthio)acetic acid was replaced by surface-treating agent 4. As a result, transparent solution E of coated titanium oxide particles was obtained. The amount of the surface-treating agent in the coated titanium oxide particles was 30% by mass.

### Synthesis Example 14

### Production of Particles Coated with Surface-Treating Agent 5

The same procedure as in Synthesis Example 9 was conducted, except that the (phenylthio)acetic acid was replaced by surface-treating agent 5. As a result, transparent solution F of coated titanium oxide particles was obtained. The amount of the surface-treating agent in the coated titanium oxide particles was 30% by mass.

### Synthesis Example 15

### Production of Particles Coated with Surface-Treating Agent 6

The same procedure as in Synthesis Example 9 is conducted, except that the (phenylthio)acetic acid is replaced by surface-treating agent 6. As a result, transparent solution G of coated titanium oxide particles is obtained. The amount of the surface-treating agent in the coated titanium oxide particles is 30% by mass.

### Synthesis Example 16

### Production of Particles Coated with Surface-Treating Agent 7

The same procedure as in Synthesis Example 9 is conducted, except that the (phenylthio)acetic acid is replaced by surface-treating agent 7. As a result, transparent solution H of coated titanium oxide particles is obtained. The amount of the surface-treating agent in the coated titanium oxide particles is 30% by mass.

### Comparative Synthesis Example 1

### Particles Treated with Silane Coupling Agent

Three grams of commercial silane coupling agent KBM-503 (3-methacryloxypropyltrimethoxysilane; manufactured by Shin-Etsu Silicones) was dissolved in 27 g of THF to obtain a 10% by mass solution. Seventy grams of 10% by mass titanium oxide particle solution A was gradually added dropwise to that solution. The resultant mixture was overheated at 80° C. for 3 hours. As a result, transparent solution E of coated titanium oxide particles was obtained.

### Comparative Synthesis Example 2

### Particles with Untreated Surface

The 10% by mass titanium oxide particle solution synthesized in Synthesis of Titanium Oxide Particles in Synthesis Example 1 was used as it was.

### Comparative Synthesis Example 3

Use was made of an SnO₂—TiO₂—ZrO₂—Sb₂O₅ composite metal oxide dispersed in methanol (trade name, Sancolloid HIT-301M1; manufactured by Nissan Chemical Industries, Ltd.; composite metal oxide concentration, 30% by mass; average particle diameter, nm). This dispersion was turbid.

### Comparative Synthesis Example 4

Ten grams of a 10% by mass THF solution of dodecylbenzenesulfonic acid was added to 40 g of 10% by mass titanium oxide particle solution A. Thus, milk-white solution F of coated titanium oxide particles was obtained. This dispersion was turbid.

### Example 1

To 10 g of the solution of 30 mass %-coated particles obtained in Synthesis Example 9 (TiO₂, 0.7 g; surface-treating agent, 0.3 g) is added 1.33 g of monomer 1 ((meth)acrylate monomer 1) represented by the following chemical formula. The solvent is distilled off with a rotary evaporator.

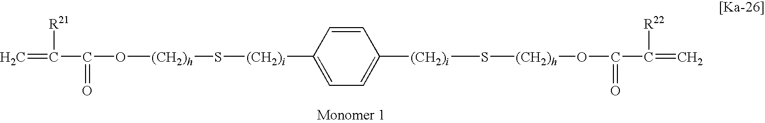

(In the formula, R²¹ and R²² each represent a methyl group; h is an integer of 2; and i is an integer of 1.)

As a result, transparent polymerizable composition A is obtained. Thereto are added 0.1 part by mass of 2,4,6-trimethylbenzoyldiphenylphosphine oxide (“Lucirin TPO” manufactured by Ciba-Geigy Ltd.), 0.1 part by mass of benzophenone (manufactured by Tokyo Kasei Kogyo Co., Ltd.), and 1.0 part by mass of a dialkyl peroxide type heat polymerization initiator (“Permicle D” manufactured by Nippon Oil & Fats Co., Ltd.). The resultant mixture is stirred at 60° C. until it becomes homogeneous. Thus, a polymerizable composition is obtained.

The polymerizable composition obtained is injected into a mold constituted of two glass plates disposed face-to-face through a 1.0-mm spacer. This composition is polymerized by irradiation with ultraviolet for 5 minutes using metal halide lamps having an output of 80 W/cm disposed respectively on the upper and lower sides of the mold each at a distance of 20 cm from the glass surface. After demolding, the composition polymerized is heated at 160° C. for 60 minutes to obtain a resin composition. An expected refractive index of this resin composition after curing is shown in Table 1.

### Example 2

The same procedure as in Example 1 is conducted, except that the coated-particle solution obtained in Synthesis Example is replaced by the coated particles obtained in Synthesis Example 10. Thus, a transparent resin composition is obtained.

### Example 3

The same procedure as in Example 1 is conducted, except that the coated-particle solution obtained in Synthesis Example is replaced by the coated particles obtained in Synthesis Example 11. Thus, a transparent resin composition is obtained.

### Example 4

The same procedure as in Example 1 is conducted, except that the coated-particle solution obtained in Synthesis Example is replaced by the coated particles obtained in Synthesis Example 12. Thus, a transparent resin composition is obtained.

### Example 5

The same procedure as in Example 1 is conducted, except that the coated-particle solution obtained in Synthesis Example 9 is replaced by the coated particles obtained in Synthesis Example 13. Thus, a transparent resin composition is obtained.

### Example 6

The same procedure as in Example 1 is conducted, except that the coated-particle solution obtained in Synthesis Example 9 is replaced by the coated particles obtained in Synthesis Example 14. Thus, a transparent resin composition is obtained.

### Example 7

The same procedure as in Example 1 is conducted, except that the coated-particle solution obtained in Synthesis Example is replaced by the coated particles obtained in Synthesis Example 15 and that the feed amount ratio is changed so as to result in a TiO₂ content of 40% by mass. Thus, a transparent resin composition is obtained.

### Example 8

The same procedure as in Example 1 is conducted, except that the coated-particle solution obtained in Synthesis Example 9 is replaced by the coated particles obtained in Synthesis Example 16 and that the feed amount ratio is changed so as to result in a TiO₂ content of 40% by mass. Thus, a transparent resin composition is obtained.

### Example 9

The same procedure as in Example 1 is conducted, except that the coated-particle solution obtained in Synthesis Example 9 is replaced by the coated particles obtained in Synthesis Example 13 and that the monomer is replaced by monomer 2 ((meth)acrylate monomer 2) represented by the following chemical formula. Thus, a transparent resin composition is obtained.

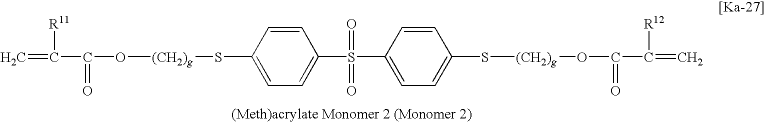

(In the formula, R¹¹ and R¹² each represent a methyl group; and g represents an integer of 2.)

### Comparative Examples 1 to 4

The same procedure as in Example 1 was conducted, except that the coated-particle solution obtained in Synthesis Example 9 was replaced by the particles obtained in Comparative Synthesis Examples 1 to 4. Thus, resin compositions were obtained.

The results of the Examples and Comparative Examples given above are summarized in Table 1.

Refractive Indexes after TiO₂ Addition

TABLE 1

| | | | | TiO₂ | Refractive |
|---|---|---|---|---|---|
| | | | | content | index after |
| | | Surface-treating | Mon- | (mass | curing |
| | Particles | agent | omer | %) | (nD) |
| Example 1 | titanium | (phenylthio)acetic | 1 | 30 | 1.67 |
| | oxide | acid | | | |
| Example 2 | titanium | surface-treating | 1 | 30 | 1.72 |
| | oxide | agent 1 | | | |
| Example 3 | titanium | surface-treating | 1 | 30 | 1.71 |
| | oxide | agent 2 | | | |
| Example 4 | titanium | surface-treating | 1 | 30 | 1.70 |
| | oxide | agent 3 | | | |
| Example 5 | titanium | surface-treating | 1 | 30 | 1.68 |
| | oxide | agent 4 | | | |
| Example 6 | titanium | surface-treating | 1 | 30 | 1.67 |
| | oxide | agent 5 | | | |
| Example 7 | titanium | surface-treating | 1 | 40 | 1.68 |
| | oxide | agent 6 | | | |
| Example 8 | titanium | surface-treating | 1 | 40 | 1.67 |
| | oxide | agent 7 | | | |
| Example 9 | titanium | surface-treating | 2 | 30 | 1.73 |
| | oxide | agent 3 | | | |
| Comparative | titanium | KBM-503 | 1 | 30 | 1.60 |
| Example 1 | oxide | | | | |
| Comparative | titanium | none | 1 | 30 | unable to |
| Example 2 | oxide | | | | be |
| | | | | | measured |
| | | | | | (turbidity) |
| Comparative | composite | none | 1 | 30 | unable to |
| Example 3 | oxide | | | | be |
| | | | | | measured |
| | | | | | (turbidity) |
| Comparative | titanium | DBS | 1 | 30 | unable to |
| Example 4 | oxide | | | | be |
| | | | | | measured |
| | | | | | (turbidity) |

* DBS: dodecylbenzenesulfonic acid

It can be expected, as apparent from the results given in Table 1, that resin compositions which are transparent and have a high refractive index after curing can be obtained in Examples 1 to 9 according to the invention. In particular, the cured resin compositions according to Examples 2, 3, 4, and 9 are expected to have a refractive index as high as 1.70 or above.

In contrast, the cured resin composition of Comparative Example 1 had a refractive index as low as 1.60. The resin compositions of Comparative Examples 2, 3, and 4 were turbid and not judged to be transparent. These resin compositions were incapable of refractive-index measurement after curing.

### Synthesis Example 17

### Synthesis of Titanium Oxide Particles, 2

Into an eggplant type flask (500 mL) were introduced g of n-butanol (manufactured by Junsei Chemical Co., Ltd.) and 4.64 g of ultrapure water (obtained by purifying desalted water with ultrapure-water production apparatus Milli-Q Labo (manufactured by Nihon Millipore Ltd.)). The contents were stirred until the water was dissolved. Thereto was added 11.85 g of titanium(IV) n-butoxide (“Titanium(IV) n-Butoxide Monomer” manufactured by Kishida Chemical Co., Ltd.). As a result, the solution became milk-white. After this mixture was stirred for 1 minute, a solution prepared by dissolving 1.723 g of p-toluenesulfonic acid monohydrate (manufactured by Wako Pure Chemical Industries, Ltd.) in 25 mL of n-butanol was added thereto with stirring. As a result, the solution became colorless and transparent. This solution was stirred at room temperature for 1 hour. Thereafter, a water-cooling type condenser was attached to the flask, and the contents were heated for 7 hours with stirring in an oil bath kept at 120° C. and then allowed to cool. Thus, a colorless and transparent dispersion of titanium oxide particles was obtained.

The dispersion obtained was diluted with n-butanol so as to result in a total amount of 250 mL, and this dilution was examined for absorption spectrum. As a result, an absorption spectrum having a peak beginning to rise at around 400 nm, which is characteristic of titanium oxide, was observed.

### Synthesis Example 18

### Synthesis of Titanium Oxide Particles, 3

Into an eggplant type flask (300 mL) was introduced 75 mL of a dispersion of fine titanium oxide particles produced in the same manner as in Synthesis Example 17. Thereto were added 45 mL of n-butanol and 3.25 g of ultrapure water. The contents were stirred until dissolution was completed. Thereto was added 8.30 g of titanium(IV) n-butoxide (“Titanium(VI) n-Butoxide Monomer” manufactured by Kishida Chemical Co., Ltd.). After this mixture was stirred for 1 minute, a solution prepared by dissolving 1.206 g of p-toluenesulfonic acid monohydrate in 25 mL of n-butanol was added thereto with stirring. This solution was stirred at room temperature for 1 hour. Thereafter, a water-cooling type condenser was attached to the flask, and the contents were heated for 8 hours with stirring in an oil bath kept at 120° C. and then allowed to cool. As a result, a slightly blue-white and transparent dispersion of titanium oxide particles was obtained.

The dispersion obtained was examined for absorption spectrum. As a result, an absorption spectrum having a peak beginning to rise at around 400 nm, which is characteristic of titanium oxide, was observed.

### Synthesis Example 19

### Synthesis of Zirconium Oxide Particles

Nitrogen was bubbled into 2,100 g of benzyl alcohol (manufactured by Junsei Chemical Co., Ltd.) for 30 minutes. While the nitrogen bubbling was being continued, 490.14 g of 70% by weight zirconium propoxide 1-propanol solution (manufactured by Aldrich Corp.) was added to the benzyl alcohol. This mixture was stirred for 30 minutes. Thereto was added 560.58 g of oleylamine (manufactured by Tokyo Kasei Kogyo Co., Ltd.). This mixture was stirred for further 30 minutes. The solution thus prepared was placed in an autoclave (metallic chamber), and nitrogen was bubbled thereinto for 30 minutes. Thereafter, the autoclave was closed, and the contents were heated to 210° C. At 24 hours thereafter, the heating was stopped and the autoclave was allowed to cool. Thus, a solution in the form of a milk-white slurry was obtained.

### Synthesis Example 20

### Treatment of Surface of Titanium Oxide Particles with Phenylphosphonic Acid, 1

A solution obtained by dissolving 1.5 g of phenylphosphonic acid (manufactured by Tokyo Kasei Kogyo Co., Ltd.) in 37.5 mL of ethanol was added, with stirring, to 250 mL of the dispersion of titanium oxide particles produced in Synthesis Example 17. This mixture was stirred at room temperature for 1 hour. The resultant solution was milk-white. Thereto were added 100 mL of ethanol and 500 mL of desalted water. This mixture was stirred for further 15 minutes. The resultant solution was transferred to eight 50-mL centrifuge tubes and subjected to centrifugal separation (2,500 g×3 minutes). As a result, a white precipitate was obtained. The supernatant was removed by decantation. Thereafter, an operation including adding the solution to the residue and obtaining a precipitate through centrifugal separation and decantation was repeated twice. Thus, the whole solution was centrifuged. Into each of the eight centrifuge tubes were introduced 2 mL of ethanol and 43 mL of desalted water. The contents in each tube was sufficiently mixed. Thereafter, the mixture was subjected to centrifugal separation (2,500 g×3 minutes), and the supernatant was removed by decantation. This operation was repeated five times in total. Furthermore, 45 mL of ethanol was introduced into each of the eight centrifuge tubes. The contents of each tube was sufficiently mixed and then subjected to centrifugal separation (2,500 g×5 minutes), and the supernatant was removed by decantation. Centrifugal separation and decantation were conducted once again in the same manner except that the amount of ethanol was changed to 25 mL.

Part of the white precipitate obtained was vacuum-dried.

The solid obtained (22 mg) was examined for XRD pattern. As a result, the solid was ascertained to be anatase-form titanium oxide. Furthermore, the 101 peak was subjected to profile fitting to calculate the particle diameter (crystallite size). As a result, the particle diameter was found to be 32 Å.

Thermogravimetric analysis was further conducted. The loss caused at 130-594° C. was taken as one ascribable to the combustion of the organic substance, and the residue was taken as the inorganic substance contained in the titanium oxide particles whose surface had been treated. The proportion by mass of the organic substance/inorganic substance in the titanium oxide particles whose surface had been treated was thus determined, and was found to be 17/83.

### Synthesis Example 21

### Treatment of Surface of Titanium Oxide Particles with Phenylphosphonic Acid, 2

The titanium oxide particle dispersion produced in Synthesis Example 18 was diluted with n-butanol so as to result in a total amount of 250 mL. A solution obtained by dissolving 1.50 g of phenylphosphonic acid in 37.5 mL of ethanol was added to the dilution with stirring. This mixture was stirred at room temperature for 1 hour. The resultant solution was milk-white. Thereto were added 100 mL of ethanol and 500 mL of desalted water. This mixture was stirred for further 15 minutes. The resultant solution was transferred to eight 50-mL centrifuge tubes and subjected to centrifugal separation (2,500 g×3 minutes). As a result, a white precipitate was obtained. The supernatant was removed by decantation. Thereafter, an operation including adding the solution to the residue and obtaining a precipitate through centrifugal separation and decantation was repeated twice. Thus, the whole solution was centrifuged. Into each of the eight centrifuge tubes were introduced 2 mL of ethanol and 43 mL of desalted water. The contents in each tube was sufficiently mixed. Thereafter, the mixture was subjected to centrifugal separation (25 g×3 minutes), and the supernatant was removed by decantation. This operation was repeated five times in total. Furthermore, 45 mL of ethanol was introduced into each of the eight centrifuge tubes. The contents of each tube was sufficiently mixed and then subjected to centrifugal separation (2,500 g×10 minutes), and the supernatant was removed by decantation.

Part of the white precipitate obtained was vacuum-dried. The solid obtained (51 mg) was examined for XRD pattern. As a result, the solid was ascertained to be anatase-form titanium oxide. Furthermore, the 101 peak was subjected to profile fitting to calculate the particle diameter (crystallite size). As a result, the particle diameter was found to be 39 Å.

Thermogravimetric analysis was further conducted. The loss caused at 130-595° C. was taken as one ascribable to the combustion of the organic substance, and the residue was taken as the inorganic substance contained in the titanium oxide particles whose surface had been treated. The proportion by mass of the organic substance/inorganic substance in the titanium oxide particles whose surface had been treated was thus determined, and was found to be 11/89.

### Synthesis Example 22

### Treatment of Surface of Titanium Oxide Particles with Surface-Treating Agent 7

A titanium oxide particle dispersion produced in the same manner as in Synthesis Example 18 was diluted with n-butanol so as to result in a total amount of 250 mL. A solution obtained by dissolving 0.90 g of the surface-treating agent 7 synthesized in Synthesis Example 30 in 25 mL of ethanol was added to a 150-mL portion of the dilution with stirring. The solution rapidly became milk-white. After the resultant mixture was stirred for 1 hour, 60 mL of ethanol and 300 mL of desalted water were added thereto. This mixture was stirred for further 30 minutes. The resultant solution was transferred to four 50-mL centrifuge tubes and subjected to centrifugal separation (2,500 g×3 minutes). As a result, a white precipitate was obtained. The supernatant was removed by decantation. Thereafter, an operation including adding the solution to the residue and obtaining a precipitate through centrifugal separation and decantation was repeated twice. Thus, the whole solution was centrifuged. Into each of the four centrifuge tubes were introduced 2 mL of ethanol and 43 mL of desalted water. The contents in each tube was sufficiently mixed. Thereafter, the mixture was subjected to centrifugal separation (2,500 g×3 minutes), and the supernatant was removed by decantation. This operation was repeated five times in total. Furthermore, 30 mL of ethanol was introduced into each of the four centrifuge tubes. The contents of each tube was sufficiently mixed and then subjected to centrifugal separation (1,800 g×30 minutes), and the supernatant was removed by decantation.

Part of the white precipitate obtained was vacuum-dried (12 mg). Thermogravimetric analysis was conducted. The loss caused at 130-701° C. was taken as one ascribable to the combustion of the organic substance, and the residue was taken as the inorganic substance contained in the titanium oxide particles whose surface had been treated. The proportion by mass of the organic substance/inorganic substance in the composition of fine titanium oxide particles was thus determined, and was found to be 19/81.

### Synthesis Example 23

### Treatment of Surface of Zirconium Oxide Particles with (Phenylthio)acetic Acid

Ten grams of (phenylthio)acetic acid was added to 100 g of the zirconium oxide particle solution synthesized in Synthesis Example 19. This mixture was stirred at room temperature for 6 hours. Thereafter, 400 mL of ethanol was added thereto, and the resultant mixture was stirred for 1 hour. The resultant solution was transferred to four 50-mL centrifuge tubes and subjected to centrifugal separation (2,500 g×3 minutes). As a result, a white precipitate was obtained. The supernatant was removed by decantation. Thereafter, an operation including adding the solution to the residue and obtaining a precipitate through centrifugal separation and decantation was repeated twice. Thus, the whole solution was centrifuged. Into each of the four centrifuge tubes was introduced 45 mL of ethanol. The contents in each tube was sufficiently mixed. Thereafter, the mixture was subjected to centrifugal separation (2,500 g×3 minutes), and the supernatant was removed by decantation. This operation was repeated four times in total. The white precipitate obtained was vacuum-dried at room temperature to thereby obtain zirconium oxide particles whose surface had been treated with (phenylthio)acetic acid.

The solid obtained was examined for XRD pattern. As a result, a zirconium oxide pattern assigned to ZrO₂ mainly belonging to tetragonal crystals (space group P42/nmc (space group No. 137)) (see No. 89-7710 in the PDF published by ICCD) was obtained, and a pattern indicating that the solid partly contained monoclinic crystals was obtained. Furthermore, the 101 peak assigned to ZrO₂ belonging to tetragonal crystals in space group P42/nmc (space group No. 137) was subjected to profile fitting to calculate the crystallite size. As a result, the crystallite size thereof was found to be 23 Å.

Thermogravimetric analysis was further conducted. The loss caused at 130-697° C. was taken as one ascribable to the combustion of the organic substance, and the residue was taken as the inorganic substance contained in the zirconium oxide particles whose surface had been treated. The proportion by mass of the organic substance/inorganic substance in the zirconium oxide particles whose surface had been treated was thus determined, and was found to be 20/80.

### Synthesis Example 24

### Synthesis of Monomer 1/Surface-Treating Agent 3 Mixture

Into a 10-L four-necked flask equipped with a stirrer, thermometer, condenser, and separator were introduced p-xylene dichloride (Tokyo Kasei Kogyo Co., Ltd.; 1,296 g), water (636 g), and methanol (Kanto Chemical Co., Inc.; 1,908 g). The atmosphere in the system was replaced with nitrogen. Subsequently, mercaptoethanol (Tokyo Kasei Kogyo Co., Ltd.; 1,266 g) was added thereto, and the temperature in the system was elevated to 60° C. Thereafter, 2,484 g of 25% aqueous sodium hydroxide solution was added dropwise thereto at a system temperature of 60-65° C. After completion of the dropwise addition, the resultant mixture was stirred for 30 minutes, and 2,544 g of water was then added thereto to conduct crystallization. Thereafter, recrystallization was conducted twice. The resultant crystals were dried to obtain 2,2′-[p-phenylenebis(methylenethio)]diethanol. Subsequently, the 2,2′-[p-phenylenebis(methylenethio)]diethanol (1,035 g) and cyclohexane (Kanto Chemical Co., Inc.; 2,051 g) were introduced into a 10-L four-necked flask equipped with a stirrer, thermometer, condenser, and separator. Azeotropic dehydration was conducted at 80° C. with stirring. Thereafter, the reaction mixture was cooled to 50° C. Thereto were added methyl methacrylate (Tokyo Kasei Kogyo Co., Ltd.; 1,613 g), 4-hydroxy-2,2,6,6-tetramethylpiperidine 1-hydroxybenzoate free radical (Tokyo Kasei Kogyo Co., Ltd.; 0.0316 g), and tetrabutyl titanate (Tokyo Kasei Kogyo Co., Ltd.; 40.32 g). Subsequently, the resultant mixture was heated to 80-85° C. and reacted for 7 hours while distilling off methanol. After the reaction, the excess methyl methacrylate was removed. To this solution were added 2,794 g of toluene and 1,907 g of 5% aqueous hydrochloric acid solution. The resultant solution was washed at 70° C. Subsequently, the solution was washed with 1,799 g of 5% aqueous sodium hydroxide solution twice and then further washed with 1,800 g of water until the washings became neutral (three times). The solvent was removed from this solution under vacuum to obtain a crude product. The crude produce was purified by silica gel chromatography using an n-hexane/ethyl acetate system. Thus, a product was obtained which had been regulated so as to have a monomer 1/surface-treating agent 3 proportion of 52/48 (mass ratio; calculated through NMR spectroscopy) and contain 4-hydroxy-2,2,6,6-tetramethylpiperidine 1-hydroxybenzoate free radical (Tokyo Kasei Kogyo Co., Ltd.; 0.002 parts by mass).

### Synthesis Example 25

### Synthesis of Monomer 1/Surface-Treating Agent 3 Mixture

The same procedure as in Synthesis Example 24 was conducted, except that hydroquinone monomethyl ether was added in an amount of 0.1 part by mass in place of the 4-hydroxy-2,2,6,6-tetramethylpiperidine 1-hydroxybenzoate free radical. Thus, a monomer 1/surface-treating agent 3=52/48 (mass ratio; calculated through NMR spectroscopy) was obtained.

### Synthesis Example 26

### Synthesis of Monomer 1

In Synthesis Example 25, the purification by silica gel chromatography using an n-hexane/ethyl acetate system was conducted. Thus, monomer 1 having a purity of 95% or higher (calculated from LC areal ratio) was obtained. The monomer 1 obtained had a refractive index (n²⁵_{D}) of 1.55.

### Synthesis Example 27

### Synthesis of Monomer 1/Surface-Treating Agent 4 Mixture

The monomer 1/surface-treating agent 3=52/48 (mass ratio) was placed in a flask. A solution of succinic anhydride (Tokyo Kasei Kogyo Co., Ltd.; 7.75 g) and triethylamine (Kanto Chemical Co., Inc.; 0.746 g) in acetone (Kanto Chemical Co., Inc.; 30 g) was added to and mixed with the contents in the flask. This mixture was stirred at 60° C. for 3 hours. Thereafter, the mixture was washed with 150 g of 5% aqueous hydrochloric acid solution once and then with 150 g of water three times. Subsequently, the mixture was dehydrated with magnesium sulfate and then vacuum-dried. Thus, a monomer 1/surface-treating agent 4=42/58 (mass ratio; calculated through NMR spectroscopy) was obtained.

### Synthesis Example 28

### Synthesis of Monomer 2

Into a tank equipped with a stirrer, thermometer, condenser, and separator were introduced 4,4′-dichlorodiphenyl sulfone (47.2 kg), N,N-dimethylformamide (70.8 kg), and potassium carbonate (27.3 kg). The atmosphere in the system was replaced with nitrogen. Subsequently, mercaptoethanol (27.0 kg) was added dropwise thereto at a system temperature of 110-120° C. After completion of the dropwise addition, the resultant mixture was stirred at 115-120° C. for 30 minutes, and 290 kg of water was then added thereto to conduct crystallization. Thereafter, recrystallization was conducted twice and the resultant crystals were dried to obtain 4,4′-bis(2-hydroxyethylthio)diphenylsulfone. Subsequently, the 4,4′-bis(2-hydroxyethylthio)diphenyl sulfone (43 kg) and toluene (170 kg) were introduced into a tank equipped with a stirrer, thermometer, condenser, and separator. Azeotropic dehydration was conducted at 80° C. with stirring. Thereafter, the reaction mixture was cooled. Thereto were added methyl methacrylate (114 kg), hydroquinone monomethyl ether (57.4 g), diethylhydroxylamine (574 g), and tetrabutyltitanate (1.157 kg). Subsequently, the resultant mixture was heated and reacted at 100-120° C. for 28 hours while distilling off methanol. After the reaction, the excess methyl methacrylate was removed. To this solution were added 123 kg of toluene and 58 kg of 5% aqueous hydrochloric acid solution. The resultant solution was washed at 70° C. Subsequently, 63 kg of heptane was added to the solution, and the resultant solution was washed with 58 kg of 25% aqueous sodium hydroxide solution four times. The solution was further washed with 58 kg of water three times until the washings became neutral. Thereafter, 57.4 g of hydroquinone monomethyl ether and 574 g of diethylhydroxylamine were added to the solution, and this mixture was filtered. The filtrate was treated under vacuum for distilling off. To the resultant solution were added 27 kg of acetone, 32 kg of methanol, and 40 g of hydroquinone monomethyl ether. This mixture was stirred at 40° C. for 1 hour, subsequently stirred at 15° C. for 15 minutes, and then filtered again. The solvent was removed from this filtrate, and 170 kg of methanol was then added to the residue. The resultant solution was cooled to cause crystallization. This white solid was taken out by filtration, washed with 42 kg of methanol, and then recovered by conducting filtration again to obtain a crude product. Hydroquinone monomethyl ether (Tokyo Kasei Kogyo Co., Ltd.) was added thereto so as to result in 0.1 part by mass, and the solvent was removed under vacuum. The monomer 2 thus obtained had a purity of 95% or higher (calculated from LC areal ratio). The monomer 2 obtained had a refractive index (n²⁵_{D}) of 1.61.

### Synthesis Example 29

### Synthesis of Surface-Treating Agent 5

Into a 2-L four-necked flask equipped with a stirrer, thermometer, condenser, and separator were introduced benzyl chloride (500 g), mercaptoethanol (370 g), and methanol (1,000 mL). Thereto was added dropwise 30% aqueous sodium hydroxide solution (705 g) at 60° C. After completion of the dropwise addition, the mixture was stirred at 60° C. for 1 hour and then washed with water (500 g) until the washings became neutral. Thereafter, the solvent was removed under vacuum to obtain surface-treating agent 5. The surface-treating agent 5 obtained had a refractive index (n²⁵_{D}) of 1.57.

### Synthesis Example 30

### Synthesis of Surface-Treating Agent 7

Surface-treating agent 5 (7.03 g) and triphenylphosphine (Tokyo Kasei Kogyo Co., Ltd.; 16.43 g) were introduced into a flask. The atmosphere in the flask was replaced with nitrogen. Thereafter, dry tetrahydrofuran (hereinafter abbreviated to THF; 100 mL) was added thereto in a nitrogen stream to completely dissolve the contents. This flask was transferred onto an ice bath, and carbon tetrabromide (Tokyo Kasei Kogyo Co., Ltd.; 20.77 g) was added little by little thereto with stirring in a nitrogen stream. Thereafter, the mixture was stirred at room temperature for 3 hours. This reaction mixture was concentrated under vacuum, and the resultant concentrate was subjected to vacuum filtration. The solid remaining on the filter paper was washed with n-hexane (Junsei Chemical Co., Ltd.; 50 mL) twice. The filtrate and the washings were put together, and the resultant mixture was concentrated under vacuum to obtain a crude product. The crude product was purified by silica gel chromatography using an n-hexane/ethyl acetate system to obtain 2-(benzylthio)ethyl bromide (6.56 g).

The 2-(benzylthio) ethyl bromide (6.56 g) was introduced into a flask, and the atmosphere in the vessel was replaced with nitrogen. Thereafter, tris(trimethylsilyl) phosphite (Tokyo Kasei Kogyo Co., Ltd.; 25.42 g) was added to and mixed with the bromide in a nitrogen stream. The mixture was stirred at 120° C. for 11 hours and then cooled to 85° C. with stirring. The excess tris(trimethylsilyl) phosphite was removed under vacuum, and after the amount of the reaction mixture came not to decrease any more, the reaction mixture was cooled to room temperature. The pressure in the vessel was returned to ordinary pressure with nitrogen. Thereafter, THF/water=100/1 (volume ratio) (20.2 mL) was added to the reaction mixture, and the contents were stirred at room temperature for 3 hours. The resultant reaction mixture was concentrated under vacuum, and ethanol was added to the residue to dissolve it. Vacuum concentration was conducted again. Chloroform was added to the residue to dissolve it, and the solution obtained was passed through a silica gel column. This column was washed with chloroform. The solution which had been passed through the column and the washings were put together, concentrated under vacuum, and vacuum-dried at room temperature (3.5 g).

### Synthesis Example 31

### Synthesis of Monomer 2/Surface-Treating Agent 1 Mixture

The monomer 2 (868 g) synthesized in Synthesis Example 28 was dissolved in toluene (870 g) with stirring. To this solution was added a solution of sodium hydroxide (0.68 g) in methanol (27.4 g) at ordinary temperature. This mixture was stirred for 2 hours. Thereafter, toluene (870 g) was added thereto, and the resultant mixture was washed with water (1,500 g). Subsequently, the mixture was washed with 50% aqueous acetone solution (1,500 g) 25 times. The mixture was further washed with 5% aqueous sodium hydroxide solution (1,500 g) and water (1,500 g). Thereafter, hydroquinone monomethyl ether (Tokyo Kasei Kogyo Co., Ltd.) was added thereto so as to result in 0.1 part by mass, and the solvent was removed under vacuum. The composition of this monomer was found to be monomer 2/surface-treating agent 1=58/42 (mass ratio; calculated through NMR spectroscopy).

### Synthesis Example 32

### Synthesis of Monomer 2/Surface-Treating Agent 2 Mixture

The same procedure as in Synthesis Example 27 was conducted, except that a monomer 2/surface-treating agent 1=58/42 (mass ratio) was used in place of the monomer 1/surface-treating agent 3=52/48 (mass ratio) in Synthesis Example 27. Thus, a monomer 2/surface-treating agent 2=60/40 (mass ratio; calculated through NMR spectroscopy) was obtained.

### Synthesis Example 33

### Treatment of Surface of Zirconium Oxide Particles with Surface-Treating Agent 6

Five grams of the surface-treating agent 6 synthesized in Synthesis Example 7 was added to 100 g of a zirconium oxide particle solution produced in the same manner as in Synthesis Example 19. This mixture was stirred at room temperature for 3 hours. A subsequent operation was conducted in the same manner as in Synthesis Example 23. Thus, zirconium oxide particles whose surface had been treated with surface-treating agent 6 were obtained. Thermogravimetric analysis was further conducted. The loss caused at 130° C.-595° C. was taken as one ascribable to the combustion of the organic substance, and the residue was taken as the inorganic substance contained in the zirconium oxide particles whose surface had been treated. The proportion by mass of the organic substance/inorganic substance in the zirconium oxide particles whose surface had been treated was thus determined, and was found to be 22/78.

### Example 10

The whole particles synthesized in Synthesis Example 20 other than those which had been taken out for analysis were mixed, in an incompletely dry state (state of being wet with ethanol), with 150 mL of THF (manufactured by Junsei Chemical Co., Ltd.; for high-performance liquid chromatography) and dispersed therein to obtain an almost transparent dispersion. Thereto was added 5.2 g of the monomer 1/surface-treating agent 3 mixture obtained in Synthesis Example 24. The resultant mixture was stirred for 10 minutes and then concentrated to about 30 mL by evaporation. This concentrate was subjected to centrifugal separation (1,000 g×20 minutes) to sediment and remove insoluble substances, contaminants, etc. The solvent was removed from the supernatant by evaporation to obtain a polymerizable composition containing titanium oxide particles. The polymerizable composition obtained had a refractive index (n 25D) of 1.66, and had a transmittance, as measured at 700 nm with a quartz cell having an optical path length of 2.0 mm, of 90%.

To 7.9 g of the polymerizable composition obtained was added 7.9 mg of Irgacure 819 (manufactured by Ciba Specialty Chemicals K.K.). This mixture was stirred at 60-65° C. for 2 hours to dissolve the additive.

This polymerizable composition was heated to 60° C. and injected into a mold constituted of two glass plates disposed face-to-face through a 2.0-mm spacer. This composition was cooled to room temperature. Thereafter, the composition was irradiated with light from the upper and lower sides for 10 seconds with LEDs (manufactured by UV PROCESS SUPPLY, INC; LED CURE-ALL 415 SPOT; peak wavelength, 415 nm) equipped with a diffuser (manufactured by Edmund Optics; holographic diffuser; thickness, 0.76 mm; diffusion angle, 30 degrees) disposed at such a distance and in such a position as to result in an irradiance of 50 mW/cm² (as measured with ultraviolet illuminometer UV-M02 and light receiver UV-42 (330-490 nm), both manufactured by ORC Manufacturing Co., Ltd.). Thereafter, the spacer was removed, and the mold was sandwiched on the upper and lower sides between sharp-cut filters (SCF-50S-42L, manufactured by Shigma Koki Co., Ltd.; critical transmission wavelength, 420 nm). Using an illuminator (UV LIGHT SOUCE UL750, manufactured by HOYA CANDEO OPTRONICS CORP.), the composition in that state was irradiated with light (70 mW/cm²; as measured with ultraviolet illuminometer UV-M02 and light receiver UV-42 (330-490 nm), both manufactured by ORC Manufacturing Co., Ltd.) from the upper and lower sides thereof for 300 seconds to thereby cure the composition. After demolding, the cured composition was heated at 50° C. in air for 1 week. Thus, a transparent resin composition containing titanium oxide particles was obtained. The refractive index of the resin composition obtained is shown in Table 2.

### Example 11

A white precipitate was obtained and subsequently washed in the same manner as in Synthesis Example 20, except that the amounts of the titanium oxide particle dispersion and phenylphosphonic acid were changed to 150 mL and 0.75 g, respectively, that the amounts of the ethanol and desalted water to be added thereafter were changed to 50 mL and 250 mL, respectively, and that the number of centrifuge tubes to be used for precipitate recovery was changed to 4. To the whole resultant white precipitate in an incompletely dry state was added 100 mL of THF (manufactured by Junsei Chemical Co., Ltd.; for high-performance liquid chromatography). The precipitate was dispersed in the THF to obtain an almost transparent dispersion. Thereto was added 4.65 g of the monomer 1/surface-treating agent 3 mixture obtained in Synthesis Example 24. The resultant mixture was stirred for 10 minutes and then concentrated to about 30 mL by evaporation. This concentrate was subjected to centrifugal separation (1,000 g×20 minutes) to sediment and remove insoluble substances, contaminants, etc. The solvent was removed from the supernatant by evaporation to obtain a polymerizable composition containing titanium oxide particles. The polymerizable composition obtained had a refractive index (n²⁵_{D}) of 1.63, and had a transmittance, as measured at 700 nm with a quartz cell having an optical path length of 2.0 mm, of 91%.

To 5 g of the polymerizable composition obtained was added 5 mg of Irgacure 819. This mixture was stirred at 60-65° C. for 2 hours to dissolve the additive.

This polymerizable composition was cured in the same manner as in Example 10. After demolding, the cured composition was heated at 50° C. in air for 3 days to obtain a transparent resin composition containing titanium oxide particles. The refractive index of the resin composition obtained is shown in Table 2.

### Example 12

The whole particles synthesized in Synthesis Example 21 other than those which had been taken out for analysis were mixed, in an incompletely dry state, with 200 mL of THF (manufactured by Junsei Chemical Co., Ltd.; for high-performance liquid chromatography) and dispersed therein to obtain a milk-white dispersion. Thereto was added 5.2 g of the monomer 1/surface-treating agent 3 mixture obtained in Synthesis Example 24. The resultant mixture was stirred for 10 minutes and then concentrated to about 80 mL by evaporation. This concentrate was subjected to centrifugal separation (1,000 g×20 minutes) to sediment and remove insoluble substances, contaminants, etc. The solvent was removed from the supernatant by conducting evaporation again to obtain a polymerizable composition containing titanium oxide. The polymerizable composition obtained had a refractive index (n²⁵_{D}) of 1.67, and had a transmittance, as measured at 700 nm with a quartz cell having an optical path length of 2.0 mm, of 91%.

To 5 g of the polymerizable composition obtained was added 5 mg of Irgacure 819. This mixture was stirred at 60-65° C. for 2 hours to dissolve the additive.

This polymerizable composition was cured in the same manner as in Example 10. After demolding, the cured composition was heated at 50° C. in air for 3 days to obtain a transparent resin composition containing titanium oxide particles. The refractive index of the resin composition obtained is shown in Table 2.

### Example 13

The whole particles synthesized in Synthesis Example 22 other than those which had been taken out for analysis were mixed, in an incompletely dry state, with 200 mL of THF (manufactured by Junsei Chemical Co., Ltd.; for high-performance liquid chromatography) and dispersed therein to obtain a slightly milk-white dispersion. Thereto was added 3.47 g of the monomer 1/surface-treating agent 3 mixture obtained in Synthesis Example 24. The resultant mixture was stirred for 10 minutes and then concentrated to about 50 mL by evaporation. This concentrate was subjected to centrifugal separation (1,000 g×20 minutes) to sediment and remove insoluble substances, contaminants, etc. The solvent was removed from the supernatant by conducting evaporation again to obtain a polymerizable composition containing titanium oxide particles. The polymerizable composition obtained had a refractive index (n²⁵_{D}) of 1.66, and had a transmittance, as measured at 700 nm with a quartz cell having an optical path length of 2.0 mm, of 90%.

To 4.5 g of the polymerizable composition obtained was added 4.5 mg of Irgacure 819. This mixture was stirred at 60-65° C. for 2 hours to dissolve the additive.

This polymerizable composition was cured in the same manner as in Example 10. After demolding, the cured composition was heated at 80° C. in air for 1 hour to obtain a transparent resin composition containing titanium oxide particles. The refractive index of the resin composition obtained is shown in Table 2.

### Example 14

In 50 mL of THF (manufactured by Junsei Chemical Co., Ltd.; special grade) were dispersed 2.21 g of zirconium oxide particles obtained in the same manner as in Synthesis Example 23. Thus, an almost transparent dispersion was obtained. Thereto was added 2.95 g of the monomer 1/surface-treating agent 3 mixture obtained in Synthesis Example 25. An ultrasonic wave was propagated to the resultant mixture for 15 minutes. Thereafter, the mixture was subjected to centrifugal separation (1,000 g×20 minutes) to sediment and remove insoluble substances, contaminants, etc. The solvent was removed from the supernatant by evaporation to obtain a polymerizable composition containing zirconium oxide particles. The polymerizable composition obtained had a refractive index (n²⁵_{D}) of 1.62, and had a transmittance, as measured at 700 nm with a quartz cell having an optical path length of 2.0 mm, of 89%.

To 4.5 g of the polymerizable composition obtained was added 4.5 mg of Irgacure 819. This mixture was stirred at 60-65° C. for 2 hours to dissolve the additive.

This polymerizable composition was heated to 60° C. and injected into a mold constituted of two glass plates disposed face-to-face through a 2.0-mm spacer. This composition was cooled to room temperature. Thereafter, the composition was irradiated with light from the upper and lower sides for 10 seconds with LEDs (415 nm; manufactured by UV PROCESS INC) equipped with a diffuser disposed at such a distance and in such a position as to result in an irradiance of 50 mW/cm² (as measured with ultraviolet illuminometer UV-M02 and light receiver UV-42 (330-390 nm), both manufactured by ORC Manufacturing Co., Ltd.). Thereafter, the spacer was removed. Using an illuminator (UV LIGHT SOUCE UL750) equipped with a short-wavelength cut filter (manufactured by Asahi Spectra Co., Ltd.; UV 350 nm; cut-on wavelength, 350 nm) disposed in the optical path, the composition was further irradiated with light (160 mW/cm²; as measured with ultraviolet integrating dosimeter UIT-250 and light receiver UVD-S365 (310-390 nm), both manufactured by Ushio Inc.) from the upper and lower sides thereof for 300 seconds to cure the composition. After demolding, the cured composition was heated at 55° C. in air for 1 day. Thus, a transparent resin composition containing zirconium oxide particles was obtained. The refractive index of the resin composition obtained is shown in Table 2.

### Example 15

In 30 mL of THF (manufactured by Junsei Chemical Co., Ltd.; special grade) were dispersed 1.9 g of zirconium oxide particles obtained in the same manner as in Synthesis Example 23. Thus, an almost transparent dispersion was obtained. Thereto was added 5.1 g of the monomer 1/surface-treating agent 3 mixture obtained in Synthesis Example 25. The resultant mixture was stirred for 10 minutes. Thereafter, the mixture was subjected to centrifugal separation (1,000 g×20 minutes) to sediment and remove insoluble substances, contaminants, etc. The supernatant was filtered through a PTFE membrane filter unit having a pore diameter of 45 μm (DISMIC-25HP045AN, manufactured by ADVANTEC). Thereafter, the solvent was distilled off by evaporation to obtain a polymerizable composition containing zirconium oxide particles. The polymerizable composition obtained had a refractive index (n²⁵_{D}) of 1.60, and had a transmittance, as measured at 700 nm with a quartz cell having an optical path length of 2.0 mm, of 92%.

To 5.5 g of the polymerizable composition obtained was added 5.5 mg of Irgacure 819. This mixture was stirred at 60-65° C. for 2 hours to dissolve the additive.

This polymerizable composition was cured in the same manner as in Example 14. After demolding, the cured composition was heated at 80° C. in air for 1 hour to obtain a transparent resin composition containing titanium oxide particles. The refractive index of the resin composition obtained is shown in Table 2.

### Example 16

In 45 mL of THF (manufactured by Junsei Chemical Co., Ltd.; special grade) were dispersed 3.6 g of zirconium oxide particles obtained in the same manner as in Synthesis Example 23. Thus, an almost transparent dispersion was obtained. Thereto was added 3.4 g of the monomer 1/surface-treating agent 3 mixture obtained in Synthesis Example 25. The resultant mixture was stirred for 10 minutes. Thereafter, the mixture was subjected to centrifugal separation (1,000 g×20 minutes) to sediment and remove insoluble substances, contaminants, etc. The supernatant was filtered through a PTFE membrane filter unit having a pore diameter of 45 μm. Thereafter, the solvent was distilled off by evaporation to obtain a polymerizable composition containing zirconium oxide particles. The polymerizable composition obtained had a refractive index (n²⁵_{D}) of 1.65, and had a transmittance, as measured at 700 nm with a quartz cell having an optical path length of 2.0 mm, of 92%.

To 5.5 g of the polymerizable composition obtained was added 5.5 mg of Irgacure 819. This mixture was stirred at 60-65° C. for 2 hours to dissolve the additive.

This polymerizable composition was cured in the same manner as in Example 14. After demolding, the cured composition was heated at 80° C. in air for 1 hour to obtain a transparent resin composition containing titanium oxide particles. The refractive index of the resin composition obtained is shown in Table 2.

### Example 17

In 40 mL of THF (manufactured by Junsei Chemical Co., Ltd.; special grade) were dispersed 2.76 g of zirconium oxide particles obtained in the same manner as in Synthesis Example 23. Thus, an almost transparent dispersion was obtained. Thereto were added 1.70 g of the monomer 1/surface-treating agent 4 mixture obtained in Synthesis Example 27 and 2.54 g of the monomer 2 obtained in Synthesis Example 28. The resultant mixture was stirred for 10 minutes. Thereafter, the mixture was subjected to centrifugal separation (1,000 g×20 minutes) to sediment and remove insoluble substances, contaminants, etc. The supernatant was filtered through a PTFE membrane filter unit having a pore diameter of 45 μm. Thereafter, the solvent was distilled off by evaporation to obtain a polymerizable composition containing zirconium oxide particles. The polymerizable composition obtained had a refractive index (n²⁵_{D}) of 1.64, and had a transmittance, as measured at 700 nm with a quartz cell having an optical path length of 2.0 mm, of 91%.

To 5.5 g of the polymerizable composition obtained was added 5.5 mg of Irgacure 819. This mixture was stirred at 60-65° C. for 2 hours to dissolve the additive.

This polymerizable composition was cured in the same manner as in Example 14. After demolding, the cured composition was heated at 120° C. in air for 2 hours to obtain a transparent resin composition containing titanium oxide particles. The refractive index of the resin composition obtained is shown in Table 2.

### Example 18

In 40 mL of THF (manufactured by Junsei Chemical Co., Ltd.; special grade) were dispersed 3.02 g of zirconium oxide particles obtained in the same manner as in Synthesis Example 23. Thus, an almost transparent dispersion was obtained. Thereto was added 3.98 g of a mixture prepared by mixing the monomer 1 obtained in Synthesis Example 26, the monomer 1/surface-treating agent 3 mixture obtained in Synthesis Example 25, and MPSMA (manufactured by Sumitomo Seika Chemicals Co., Ltd.) in such a proportion as to result in a monomer 1/surface-treating agent 3/MPSMA (bis(4-methacryloylthiophenyl) sulfide) mass ratio of 55/15/30. The resultant mixture was stirred for 10 minutes. Thereafter, this mixture was subjected to centrifugal separation (1,000 g×20 minutes) to sediment and remove insoluble substances, contaminants, etc. The supernatant was filtered through a PTFE membrane filter unit having a pore diameter of 45 μm. Thereafter, the solvent was distilled off by evaporation to obtain a polymerizable composition containing zirconium oxide particles. The polymerizable composition obtained had a refractive index (n²⁵_{D}) of 1.65, and had a transmittance, as measured at 700 nm with a quartz cell having an optical path length of 2.0 mm, of 90%.

To 5 g of the polymerizable composition obtained was added 5 mg of Irgacure 819. This mixture was stirred at 60-65° C. for 2 hours to dissolve the additive.

This polymerizable composition was cured in the same manner as in Example 14. After demolding, the cured composition was heated at 120° C. for 2 hours with evacuation with a vacuum pump to obtain a transparent resin composition containing titanium oxide particles. The refractive index of the resin composition obtained is shown in Table 2.

### Example 19

In 40 mL of THF (manufactured by Junsei Chemical Co., Ltd.; special grade) were dispersed 2.76 g of zirconium oxide particles obtained in the same manner as in Synthesis Example 23. Thus, an almost transparent dispersion was obtained. Thereto were added 2.54 g of the monomer 2/surface-treating agent 1 mixture obtained in Synthesis Example 31 and 1.70 g of the monomer 1 obtained in Synthesis Example 26. The resultant mixture was stirred for 10 minutes. Thereafter, the mixture was subjected to centrifugal separation (1,000 g×30 minutes) to sediment and remove insoluble substances, contaminants, etc. The solvent was distilled off the supernatant by evaporation to obtain a polymerizable composition containing zirconium oxide particles. The polymerizable composition obtained had a refractive index (n²⁵_{D}) of 1.65, and had a transmittance, as measured at 700 nm with a quartz cell having an optical path length of 2.0 mm, of 87%.

To 5.5 g of the polymerizable composition obtained was added 5.5 mg of Irgacure 819. This mixture was stirred at 60-65° C. for 2 hours to dissolve the additive.

This polymerizable composition was cured in the same manner as in Example 14, except that the composition was injected into the mold and this mold containing the composition was placed in a 60° C. oven for 10 minutes and subjected to light irradiation immediately thereafter. After demolding, the cured composition was heated at 120° C. in air for 2 hours to obtain a transparent resin composition containing titanium oxide particles. The refractive index of the resin composition obtained is shown in Table 2.

### Example 20

In 40 mL of THF (manufactured by Junsei Chemical Co., Ltd.; special grade) were dispersed 2.76 g of zirconium oxide particles obtained in the same manner as in Synthesis Example 23. Thus, an almost transparent dispersion was obtained. Thereto were added 2.54 g of the monomer 2/surface-treating agent 2 mixture obtained in Synthesis Example 32 and 1.70 g of the monomer 1 obtained in Synthesis Example 26. The resultant mixture was stirred for 10 minutes. Thereafter, the mixture was subjected to centrifugal separation (1,000 g×30 minutes) to sediment and remove insoluble substances, contaminants, etc. The solvent was distilled off the supernatant by evaporation to obtain a polymerizable composition containing zirconium oxide particles. The polymerizable composition obtained had a refractive index (n²⁵_{D}) of 1.64. Although this polymerizable composition was slightly milk-white at room temperature, it became transparent upon heating.

To 5.5 g of the polymerizable composition obtained was added 5.5 mg of Irgacure 819. This mixture was stirred at 60-65° C. for 2 hours to dissolve the additive.

This polymerizable composition was cured in the same manner as in Example 14, except that the composition was injected into the mold and this mold containing the composition was placed in an 80° C. oven for 30 minutes and subjected to light irradiation immediately thereafter. After demolding, the cured composition was heated at 120° C. in air for 2 hours to obtain a transparent resin composition containing titanium oxide particles. The refractive index of the resin composition obtained is shown in Table 2.

### Example 21

A polymerizable composition containing zirconium oxide particles was obtained in the same manner as in Example 16, except that 3.9 g of the zirconium oxide particles obtained in Synthesis Example 33 were used in place of the 3.6 g of zirconium oxide particles obtained in the same manner as in Synthesis Example 23. The polymerizable composition obtained had a refractive index (n²⁵_{D}) of 1.64, and had a transmittance, as measured at 700 nm with a quartz cell having an optical path length of 2.0 mm, of 92%. To 5.5 g of the polymerizable composition obtained was added 5.5 mg of Irgacure 819. This mixture was stirred at 60-65° C. for 2 hours to dissolve the additive. This polymerizable composition was cured in the same manner as in Example 14. After demolding, the cured composition was heated at 80° C. in air for 1 hour and then further heated at 100° C. in air for 1 hour to obtain a transparent resin composition containing titanium oxide particles. The refractive index of the resin composition obtained is shown in Table 2.

### Comparative Example 5

Sixty milliliters of THF was added to 1.8 g of ultrafine titanium oxide particles TTO-51N (manufactured by Ishihara Sangyo Kaisha, Ltd.; average particle diameter, 20 nm) and 0.36 g of phenylphosphonic acid. This mixture was stirred at room temperature for 4 hours. Thereto was added 3.84 g of the monomer 1/surface-treating agent 3 mixture obtained in Synthesis Example 24. The resultant mixture was stirred at room temperature for 5 hours. Thereafter, the solvent was distilled off by evaporation. The polymerizable composition thus obtained was pure white (titanium oxide content calculated from feed amount ratio, 30% by mass).

To 5 g of this polymerizable composition was added 5 mg of Irgacure 819. This mixture was stirred at 60-65° C. for 2 hours to dissolve the additive.

This polymerizable composition was cured in the same manner as in Example 10. After demolding, the cured composition was heated at 50° C. in air for 1 day to obtain a resin composition. The resin composition obtained was pure white and hardly transmitted light.

TABLE 2

| | | | | | Refractive | |
|---|---|---|---|---|---|---|
| | | | | | index | Transmittance |
| | | Surface- | | Content | after | at |
| | | treating | | of particles | curing | 700 nm |
| | Particles | agent | Monomer | [mass %]* | (n23d) [—] | [%] |
| Example | titanium | phenylphosphonic | monomer 1 | 33 | 1.69 | 80 |
| 10 | oxide | acid | | | | |
| | | surface- | | | | |
| | | treating | | | | |
| | | agent 3 | | | | |
| Example | titanium | phenylphosphonic | monomer 1 | 24 | 1.67 | 84 |
| 11 | oxide | acid | | | | |
| | | surface- | | | | |
| | | treating | | | | |
| | | agent 3 | | | | |
| Example | titanium | phenylphosphonic | monomer 1 | 35 | 1.71 | 86 |
| 12 | oxide | acid | | | | |
| | | surface- | | | | |
| | | treating | | | | |
| | | agent 3 | | | | |
| Example | titanium | surface- | monomer 1 | 33 | 1.70 | 84 |
| 13 | oxide | treating | | | | |
| | | agent 3 | | | | |
| | | surface- | | | | |
| | | treating | | | | |
| | | agent 7 | | | | |
| Example | zirconium | (phenylthio)- | monomer 1 | 34 | 1.66 | 89 |
| 14 | oxide | acetic acid | | | | |
| | | surface- | | | | |
| | | treating | | | | |
| | | agent 3 | | | | |
| Example | zirconium | (phenylthio)- | monomer 1 | 23 | 1.64 | 89 |
| 15 | oxide | acetic acid | | | | |
| | | surface- | | | | |
| | | treating | | | | |
| | | agent 3 | | | | |
| Example | zirconium | (phenylthio)- | monomer 1 | 43 | 1.68 | 85 |
| 16 | oxide | acetic acid | | | | |
| | | surface- | | | | |
| | | treating | | | | |
| | | agent 3 | | | | |
| Example | zirconium | (phenylthio)- | monomer 1 | 32 | 1.67 | 91 |
| 17 | oxide | acetic acid | monomer 2 | | | |
| | | surface- | | | | |
| | | treating | | | | |
| | | agent 4 | | | | |
| Example | zirconium | (phenylthio)- | monomer 1 | 35 | 1.67 | 87 |
| 18 | oxide | acetic acid | MPSMA | | | |
| | | surface- | | | | |
| | | treating | | | | |
| | | agent 3 | | | | |
| Example | zirconium | (phenylthio)- | monomer 1 | 32 | 1.67 | 84 |
| 19 | oxide | acetic acid | monomer 2 | | | |
| | | surface- | | | | |
| | | treating | | | | |
| | | agent 1 | | | | |
| Example | zirconium | (phenylthio)- | monomer 1 | 32 | 1.66 | 84 |
| 20 | oxide | acetic acid | monomer 2 | | | |
| | | surface- | | | | |
| | | treating | | | | |
| | | agent 2 | | | | |
| Example | zirconium | surface- | monomer 1 | 43 | 1.67 | 87 |
| 21 | oxide | treating | | | | |
| | | agent 3 | | | | |
| | | surface- | | | | |
| | | treating | | | | |
| | | agent 6 | | | | |
| Comparative | titanium | phenylphosphonic | monomer 1 | 30 | unable | 0 |
| Example 5 | oxide | acid | | | to be | |
| | | surface- | | | measured | |
| | | treating | | | | |
| | | agent 3 | | | | |

*determined by thermogravimetric analysis of cured composition (determined from feed amount ratio in Comparative Example 5)

As apparent from the results given in Table 2, resin compositions which were transparent and had a high refractive index after curing were able to be obtained in Examples 10 to 21 according to the invention. In particular, the cured resin compositions according to Examples 12 and 13 had a refractive index as high as 1.70 or above.

The invention was explained above by reference to Examples/embodiments which are thought to be most practical and preferred at this point of time. However, the invention should not be construed as being limited to the Examples/embodiments disclosed in the description. The invention can be suitably modified unless the modification departs from the spirit or ideas of the invention which can be read in the claims and whole description. High-refractive-index resin compositions involving such modifications should also be understood to be within the technical scope of the invention.

This application is based on a Japanese patent application filed on Apr. 28, 2006 (Application No. 2006-126430) and a Japanese patent application filed on Apr. 19, 2007 (Application No. 2007-110687), the contents thereof being herein incorporated by reference.

### INDUSTRIAL APPLICABILITY

The invention can provide a high-refractive-index resin composition containing particles, and this composition can be used as an optical material which is transparent and has a high refractive index.

1. A high-refractive-index resin composition obtained by polymerizing a polymerizable composition comprising: particles at least coated with a surface-treating agent and having an average particle diameter of 10 nm or smaller; and a polymerizable monomer, wherein the content of the particles excluding the surface-treating agent, X (% by mass), and the refractive index of the high-refractive-index resin composition, Y (n²³_{d}), have a relationship between these which is represented by the following general formula 1:
Y≧0.0035X+1.52
(wherein 20≦x≦60 and Y≦2.0).

2. A high-refractive-index resin composition having a refractive index (n²³_{d}) of 1.66 or higher and obtained by polymerizing a polymerizable composition comprising: particles at least coated with a surface-treating agent and a polymerizable monomer, wherein the content of the particles excluding the surface-treating agent is from 20% by mass to 60% by mass based on the whole composition.

3. The high-refractive-index resin composition according to claim 2, wherein the particles have an average particle diameter of 10 nm or smaller.

4. The high-refractive-index resin composition according to any one of claims 1 to 3, wherein the polymerizable monomer is a (meth)acrylic monomer.

5. The high-refractive-index resin composition according to any one of claims 1 to 4, wherein at least one surface-treating agent includes:
a part (A) having at least one of adsorbability onto the particles and reactivity with the particles,
a part (B) which imparts compatibility with the polymerizable monomer to the coated particles, and
a part (C) having a high refractive index.

6. The high-refractive-index resin composition according to claim 5, wherein the part (A) contains at least one of a group capable of forming ionic bond, a group capable of reacting with the particles to form covalent bond, a group capable of forming hydrogen bond, and a group capable of forming coordinate bond.

7. The high-refractive-index resin composition according to claim 6, wherein the group capable of forming ionic bond comprises at least one of an acidic group or salt thereof and a basic group or salt thereof.

8. The high-refractive-index resin composition according to claim 6 or 7, wherein the group capable of reacting with the particles to form covalent bond comprises at least one of —Si(OR¹)₃, —Ti(OR²)₃ (wherein R¹ and R² each represent a hydrogen atom, a hydrocarbon group having 1-25 carbon atoms, or an aromatic group), an isocyanate group, an epoxy group, an episulfide group, a hydroxyl group, a thiol group, a phosphine oxide, a carboxyl group, a phosphate group, and a phosphonate group.

9. The high-refractive-index resin composition according to any one of claims 5 to 8, wherein the part (B) comprises at least one of a (meth)acryl group, a polyalkylene glycol group, and an aromatic group.

10. The high-refractive-index resin composition according to any one of claims 5 to 9, wherein the part (C) is constituted of at least one sulfur atom and one aromatic ring and the surface-treating agent itself has a refractive index (n25D) of 1.55 or higher.

11. The high-refractive-index resin composition according to any one of claims 1 to 10, wherein the particles are metal oxide.

12. The high-refractive-index resin composition according to claim 11, wherein the metal oxide comprises at least one member selected from the group consisting of titanium oxide, zirconium oxide, and salts of titanic acid.

13. The high-refractive-index resin composition according to any one of claims 1 to 12, wherein the polymerizable monomer comprises a polyfunctional (meth)acrylate compound represented by the following general formula (I) or general formula (II): 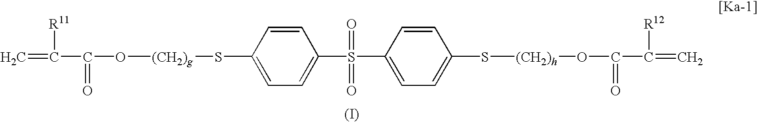
(wherein R¹¹ and R¹² each independently represent a hydrogen atom or a methyl group, and g and h each independently represent an integer of 1-6) 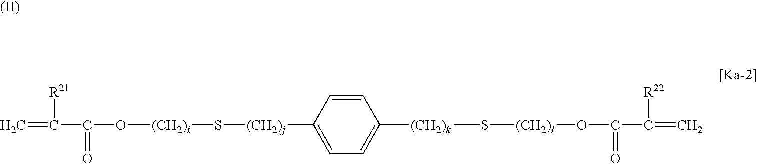
(wherein R²¹ and R²² each independently represent a hydrogen atom or a methyl group, and i, j, k, and l each independently represent an integer of 1-6).

14. The high-refractive-index resin composition according to any one of claims 1 to 13, which, when having a thickness of 2.0 mm, has a light transmittance of 80% or higher at 700 nm.

15. An optical member comprising the high-refractive-index resin composition according to any one of claims 1 to 14.

16. The optical member according to claim 15, which is an optical part for imaging.

17. The polymerizable composition as described in any one of claims 1 to 16.

18. A polymerizable composition comprising:
particles at least coated with a surface-treating agent and having an average particle diameter of 10 nm or smaller; and a polymerizable monomer, wherein at least one surface-treating agent includes a part (A) having at least one of adsorbability onto the particles and reactivity with the particles, a part (B) which imparts compatibility with the polymerizable monomer to the coated particles, and a part (C) having a high refractive index.

19. The polymerizable composition according to claim 18, wherein the polymerizable monomer is a (meth)acrylic monomer.

20. The polymerizable composition according to claim 18 or 19, wherein the content of the particles excluding the surface-treating agent is from 20% by mass to 60% by mass.

21. The polymerizable composition according to any one of claims 18 to 20, wherein the part (A) contains at least one of a group capable of forming ionic bond, a group capable of reacting with the particles to form covalent bond, a group capable of forming hydrogen bond, and a group capable of forming coordinate bond.

22. The polymerizable composition according to claim 21, wherein the group capable of forming ionic bond comprises at least one of an acidic group or salt thereof and a basic group or salt thereof.

23. The polymerizable composition according to claim 21 or 22, wherein the group capable of reacting with the particles to form covalent bond comprises at least one of —Si(OR¹)₃, —Ti(OR²)₃ (wherein R¹ and R² each represent a hydrogen atom, a hydrocarbon group having 1-25 carbon atoms, or an aromatic group), an isocyanate group, an epoxy group, an episulfide group, a hydroxyl group, a thiol group, a phosphine oxide, a carboxyl group, a phosphate group, and a phosphonate group.

24. The polymerizable composition according to any one of claims 18 to 23, wherein the part (B) comprises at least one of a (meth)acryl group, a polyalkylene glycol group, and an aromatic group.

25. The polymerizable composition according to any one of claims 18 to 24, wherein the part (C) is constituted of at least one sulfur atom and one aromatic ring and the surface-treating agent itself has a refractive index (n²⁵_{D}) of 1.55 or higher.

26. The polymerizable composition according to any one of claims 18 to 25, wherein the particles are metal oxide.

27. The polymerizable composition according to claim 26, wherein the metal oxide comprises at least one member selected from the group consisting of titanium oxide, zirconium oxide, and salts of titanic acid.

28. The polymerizable composition according to any one of claims 18 to 27, wherein the polymerizable monomer comprises a polyfunctional (meth)acrylate compound represented by the following general formula (I) or general formula (II): 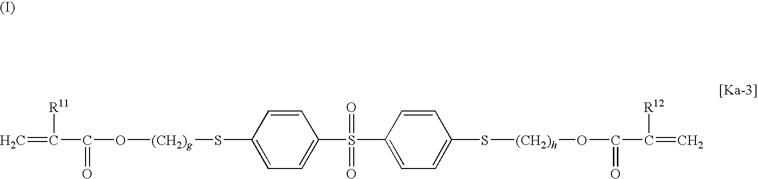
(wherein R¹¹ and R¹² each independently represent a hydrogen atom or a methyl group, and g and h each independently represent an integer of 1-6) 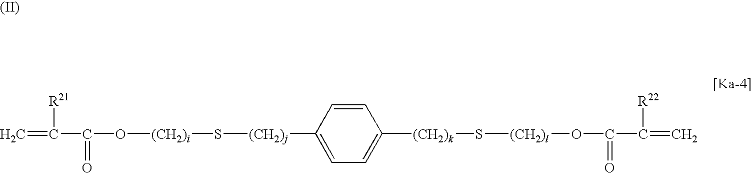
(wherein R²¹ and R²² each independently represent a hydrogen atom or a methyl group, and i, j, k, and l each independently represent an integer of 1-6).

29. The polymerizable composition according to any one of claims 18 to 28, which, when examined with a quartz cell having an optical path length of 2.0 mm, has a light transmittance of 80% or higher at 700 nm.

30. The polymerizable composition according to any one of claims 18 to 29, which contains a polymerization initiator.
